(19) United States
(12) Patent Application Publication
(10) Pub. No.: US 2026/0040368 A1
(43) Pub. Date: Feb. 5, 2026

(54) RANDOM ACCESS METHOD AND APPARATUS, TERMINAL, NETWORK DEVICE, AND MEDIUM

(71) Applicant: VIVO MOBILE COMMUNICATION CO., LTD., Dongguan (CN)

(72) Inventors: Chaojun ZENG, Dongguan (CN); Lihui WANG, Dongguan (CN); Xiaohang CHEN, Dongguan (CN); Xueming PAN, Dongguan (CN)

(73) Assignee: VIVO MOBILE COMMUNICATION CO., LTD., Dongguan (CN)

(21) Appl. No.: 19/356,052

(22) Filed: Oct. 11, 2025

Related U.S. Application Data
(63) Continuation of application No. PCT/CN2024/087045, filed on Apr. 10, 2024.

(30) Foreign Application Priority Data
Apr. 14, 2023 (CN) 202310404720.3

(51) Int. Cl. H04W 74/0833; H04L 5/00

(52) U.S. Cl. CPC H04W 74/0833; H04L 5/0044; H04L 5/0055

(57) ABSTRACT

A random access method and apparatus, a terminal, a network device, and a medium, are provided. The random access method includes: executing, by a terminal, random access in a random access mode, where the random access mode is used for determining resources used by a target transmission, and the target transmission includes at least one of the following: a Physical Random Access CHannel (PRACH) transmission corresponding to the random access or a target uplink transmission during a process of the random access.

### CROSS-REFERENCE TO RELATED APPLICATIONS

This application is a continuation of International Application No. PCT/CN2024/087045, filed Apr. 10, 2024, which claims the priority of Chinese Patent No. 202310404720.3, filed Apr. 14, 2023. The entire contents of each of the above-referenced applications are expressly incorporated herein by reference.

### TECHNICAL FIELD

This application belongs to the technical field of communication, and specifically relates to a random access method and apparatus, a terminal, a network device, and a medium.

### BACKGROUND

Currently, in a network in which SubBand Full Duplex (SBFD) features are deployed, a random access procedure for a terminal supporting the SBFD features can use uplink resources in an uplink subband configured (or indicated) in semi-static downlink symbols or semi-static flexible symbols.

However, there is still no solution on how to determine the uplink resources specifically used in the above random access procedure.

### SUMMARY

Embodiments of this application provide a random access method and apparatus, a terminal, a network device, and a medium.

According to a first aspect, a random access method is provided, which is executed by a terminal. The method includes: executing, by the terminal, random access in a random access mode, where the random access mode is used for determining resources used by a target transmission, and the target transmission includes at least one of the following: a Physical Random Access CHannel (PRACH) transmission corresponding to the random access and a target uplink transmission during a procedure of the random access.

According to a second aspect, a random access method is provided, which is executed by a network device. The method includes: executing, by the network device, random access in a random access mode, where the random access mode is used for determining resources used by a target transmission, and the target transmission includes at least one of the following: a PRACH transmission corresponding to the random access and a target uplink transmission during a procedure of the random access.

According to a third aspect, a random access apparatus is provided. The apparatus includes a first execution module. The first execution module is configured to execute random access in a random access mode. The random access mode is used for determining resources used by a target transmission, and the target transmission includes at least one of the following: a PRACH transmission corresponding to the random access and a target uplink transmission during a procedure of the random access.

According to a fourth aspect, a random access apparatus is provided. The apparatus includes a second execution module. The second execution module is configured to execute random access in a random access mode. The random access mode is used for determining resources used by a target transmission, and the target transmission includes at least one of the following: a PRACH transmission corresponding to the random access and a target uplink transmission during a procedure of the random access.

According to a fifth aspect, a terminal is provided. The terminal includes a processor and a memory. The memory stores a program or an instruction runnable on the processor. The program or the instruction, when executed by the processor, implements steps of the method according to the first aspect.

According to a sixth aspect, a terminal is provided, including a processor and a communication interface. The processor is configured to execute random access in a random access mode. The random access mode is used for determining resources used by a target transmission, and the target transmission includes at least one of the following: a PRACH transmission corresponding to the random access and a target uplink transmission during a procedure of the random access.

According to a seventh aspect, a network device is provided. The network device includes a processor and a memory. The memory stores a program or an instruction runnable on the processor. The program or the instruction, when executed by the processor, implements steps of the method according to the second aspect.

According to an eighth aspect, a network device is provided, including a processor and a communication interface. The processor is configured to execute random access in a random access mode. The random access mode is used for determining resources used by a target transmission, and the target transmission includes at least one of the following: a PRACH transmission corresponding to the random access and a target uplink transmission during a procedure of the random access.

According to a ninth aspect, a readable storage medium is provided. The readable storage medium stores a program or an instruction. The program or the instruction, when executed by a processor, implements steps of the method according to the first aspect or implements steps of the method according to the second aspect.

According to a tenth aspect, a wireless communication system is provided, including a terminal and a network device. The terminal may be configured to execute steps of the method according to the first aspect, and the network device may be configured to execute steps of the method according to the second aspect.

In an eleventh aspect, a chip is provided. The chip includes a processor and a communication interface. The communication interface is coupled to the processor. The processor is configured to run a program or an instruction to implement the method according to the first aspect or implement the method according to the second aspect.

According to a twelfth aspect, a computer program/program product is provided. The computer program/program product is stored in a storage medium. The program/program product is executed by at least one processor to implement steps of the random access method according to the first aspect or implement steps of the random access method according to the second aspect.

### BRIEF DESCRIPTION OF THE DRAWINGS

FIG. 1 is a block diagram of an applicable wireless communication system according to an embodiment of this application;

FIG. 2 is a schematic diagram of SBFD;

FIG. 3 is a first schematic diagram of mapping between Synchronization Signal Blocks (SSBs) and Physical Random Access CHannel Occasions (PRACH Occasions (ROs));

FIG. 4 is a second schematic diagram of mapping between SSBs and ROs;

FIG. 5 is a third schematic diagram of mapping between SSBs and ROs;

FIG. 6 is a fourth schematic diagram of mapping between SSBs and ROs;

FIG. 7 is a schematic diagram of preambles and groups corresponding to a single valid RO;

FIG. 8 is a flowchart of a random access method according to an embodiment of this application;

FIG. 9 is a flowchart of another random access method according to an embodiment of this application;

FIG. 10 is a schematic structural diagram of a random access apparatus according to an embodiment of this application;

FIG. 11 is a schematic structural diagram of another random access apparatus according to an embodiment of this application;

FIG. 12 is a schematic diagram of a communication device according to an embodiment of this application;

FIG. 13 is a schematic structural diagram of hardware of a terminal according to an embodiment of this application; and

FIG. 14 is a schematic structural diagram of hardware of a network device according to an embodiment of this application.

### DETAILED DESCRIPTION

The following describes the technical solutions in the embodiments of this application with reference to the accompanying drawings in the embodiments of this application. Apparently, the described embodiments are some of the embodiments of this application rather than all of the embodiments. All other embodiments obtained by a person of ordinary skill in the art based on the embodiments of this application fall within the protection scope of this application.

The terms such as “first” and “second” in this application are used to distinguish similar objects, but are not used to describe a specific sequence or order. It should be understood that the terms used in this way may be transposed where appropriate, so that embodiments of this application may be implemented in a sequence other than those illustrated or described herein. In addition, objects defined by “first” and “second” are generally of the same class and do not limit a quantity of objects. For example, one or more first objects may be arranged. In addition, “or” in this application indicates at least one of connected objects. For example, “A or B” covers three solutions, that is, Solution I: including A and excluding B; Solution II: including B and excluding A; and Solution III: including both A and B. The character “/” generally indicates an “or” relationship between the associated objects.

The term “indication” in this application may be either a direct indication (or an explicit indication) or an indirect indication (or an implicit indication). The direct indication may be understood as that the transmitter clearly tells the receiver the specific information, the operation to be performed or the request result, and the like in the indication transmitted; and the indirect indication may be understood as that the receiver determines the corresponding information according to the indication transmitted by the transmitter, or makes a judgment and determines the operation to be performed or the request result, and the like according to the judgment result.

It should be noted that, the technology described in embodiments of this application may be applied to a Long Term Evolution (LTE)/LTE-Advanced (LTE-A) system, and may be further applied to another wireless communication system, such as a Code Division Multiple Access (CDMA) system, a Time Division Multiple Access (TDMA) system, a Frequency Division Multiple Access (FDMA) system, an Orthogonal Frequency Division Multiple Access (OFDMA) system, a Single-Carrier Frequency-Division Multiple Access (SC-FDMA) system, or another system. Terms “system” and “network” in embodiments of this application are usually interchangeably used, and the described technology may be applied to both the system and the radio technology mentioned above, or may be applied to another system and radio technology. The following description describes the New Radio (NR) system for example purposes, and the NR terms are used in most of the following description. Nevertheless, these technologies may also be applied to systems other than NR system, such as a 6^{th} Generation (6G) communication system.

FIG. 1 is block diagram of an applicable wireless communication system according to an embodiment of this application. The wireless communication system includes terminals 11 and a network device 12. The terminal 11 may be a terminal device such as a mobile phone, a tablet personal computer, a laptop computer, a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, a flight vehicle, Vehicle User Equipment (VUE), a ship-borne equipment, a Pedestrian User Equipment (PUE), a smart home appliance (a home device with a wireless communication function, such as a refrigerator, a television, a washing machine, or furniture), a game console, a personal computer, a teller machine, or a self-service machine. The wearable device includes a smart watch, a smart band, a smart headset, smart glasses, smart jewelry (a smart bracelet, a smart chain bracelet, a smart ring, a smart necklace, a smart ankle bangle, a smart ankle chain, and the like), a smart wristband, smart clothing, and the like. The vehicle user equipment may also be referred to as an in-vehicle terminal, an in-vehicle controller, an in-vehicle module, an in-vehicle component, an in-vehicle chip, an in-vehicle unit, or the like. It should be noted that the specific type of the terminal 11 is not limited in embodiments of this application. The network device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AS), or a Wireless Fidelity (WiFi) node. The base station may be referred to as a Node B (NB), an Evolved Node B (eNB), the next generation Node B (gNB), a New Radio Node B (NR Node B), an access point, a Relay Base Station (RBS), a Serving Base Station (SBS), a Base Transceiver Station (BTS), a radio base station, a radio transceiver, a Basic Service Set (BSS), an Extended Service Set (ESS), a Home Node B (HNB), a home evolved Node B, a Transmission Reception Point (TRP) or some other suitable terms in the field as long as the same technical effect is achieved, and the base station is not limited to a specific technical word. It should be noted that in the embodiments of this application, introduction is made only taking the base station in the NR system as an example, and the specific type of the base station is not limited.

A random access method and apparatus, a terminal, a network device, and a medium provided in the embodiments of this application are described in detail below through some embodiments and application scenarios thereof with reference to the accompanying drawings.

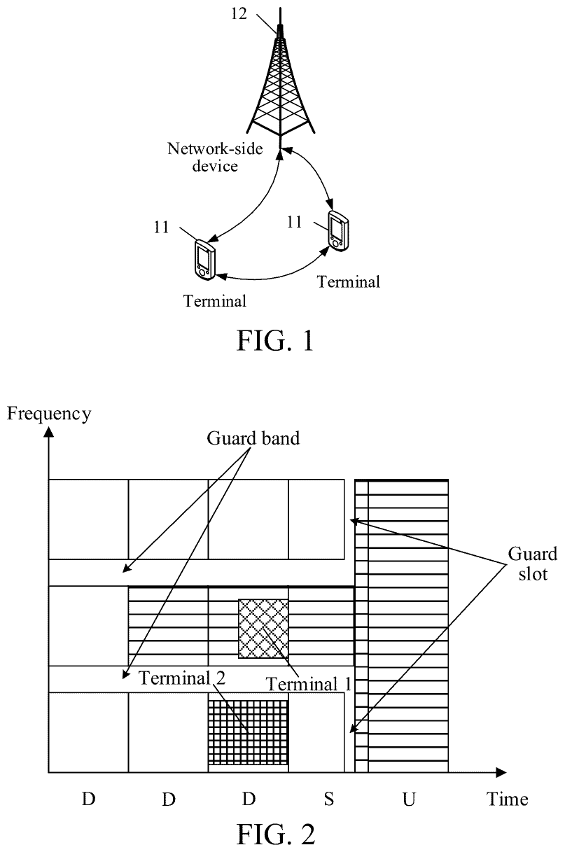

When a conventional cellular network is deployed, a Frequency Division Duplex (FDD) mode or a Time Division Duplex (TDD) mode may be used based on an available spectrum, a service characteristic, and the like. When the FDD is used, uplink transmission and downlink transmission are located at different frequencies, do not interfere with each other, and may be simultaneously performed. When the TDD is used, uplink transmission and downlink transmission are located at a same frequency and are interleaved in a time division mode. To more flexibly utilize limited spectrum resources to dynamically match service requirements and improve resource utilization efficiency and performance of data transmission such as uplink coverage and time delay, a flexible duplex mode is proposed. This flexible duplex mode is SBFD: network full duplex, that is, uplink transmission and downlink transmission can be simultaneously performed at different frequency domain locations at a same moment, where a guard band may be set between frequency domain locations (corresponding to duplex subbands) corresponding to different transmission directions, to avoid interference between the uplink transmission and the downlink transmission; and terminal half duplex, that is, similar to TDD, only uplink transmission or downlink transmission can be performed at a same moment, and the uplink transmission and the downlink transmission cannot be performed at the same time. For example, as shown in FIG. 2, the network side semi-statically divides, in some downlink symbols, a frequency domain of a single carrier into three duplex subbands, where downlink duplex subbands are provided on two sides of the carrier, and an uplink duplex subband is provided in the middle of the carrier, to reduce interference to an adjacent carrier. In the third slot, Terminal 1 and Terminal 2 respectively perform uplink transmission and downlink reception. It may be understood that, in the duplex mode, the uplink transmission and the downlink transmission on a network side at the same moment can only be directed to different terminals.

Analog beamforming (especially for FR2) is widely used in the NR network, and each analog beam is used based on a time division multiplexing mode to serve a terminal within coverage of each analog beam. For SSB transmission, each SSB index (that is, SSB index) may be in a one-to-one correspondence to each analog beam. The network side notifies a terminal of an SSB index set corresponding to actual SSB transmission by using an ssb-PositionsInBurst parameter in signaling such as SIB1, and further plans, for each actually transmitted SSB index, corresponding PRACH resources, so that a terminal within coverage of an SSB analog beam corresponding to an SSB index can initiate random access by using the PRACH resources corresponding to the SSB index, to match a time division multiplexing rule of the analog beam of the network side and extend coverage of a cell.

The above PRACH resources corresponding to an SSB index may be ROs or an RO subset individually corresponding to the SSB index, or may be PRACH preambles (that is, PRACH preambles) or a PRACH preamble subset individually corresponding to the SSB index in ROs shared with one or more SSB indexes. A specific correspondence depends on configuration on the network side, that is, configuration of a parameter N. N is a quantity of SSB indexes corresponding to a single valid RO, and N allowed to be configured by NR includes an integer or a fraction such as 16, 8, 4, 2, 1, ½, ¼, or ⅛.

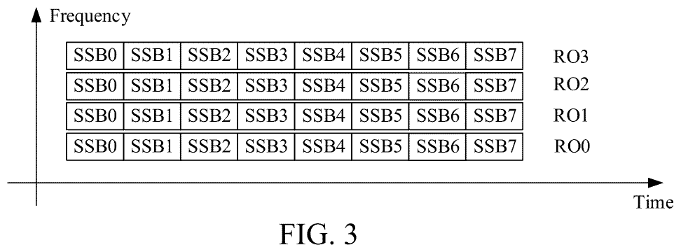

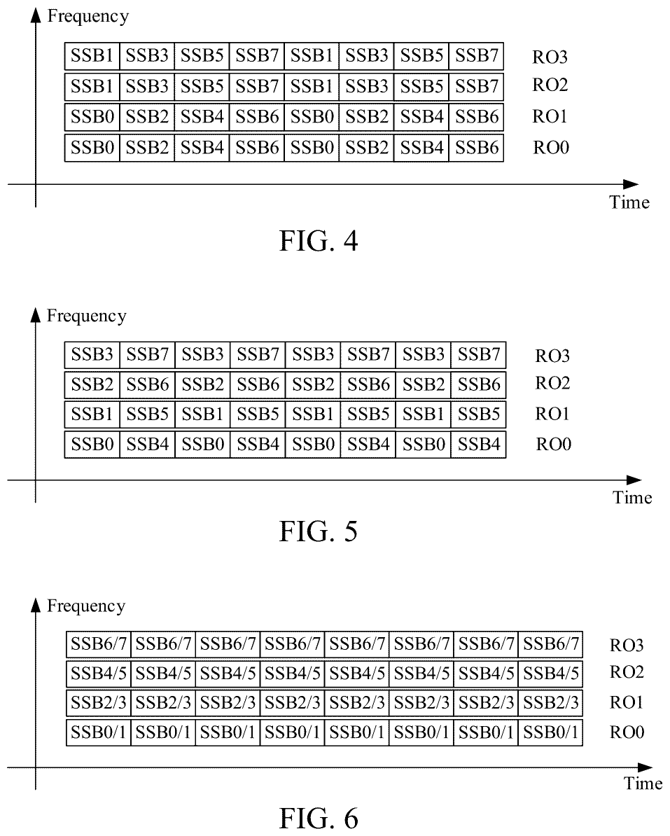

For example, it is assumed that the SSB index has a value of 0 to 7, frequency division multiplexing is used for ROs, and four ROs may be multiplexed at a single moment. Then, when N is ¼, a mapping between SSBs and ROs is shown in FIG. 3. When N is ½, a mapping between SSBs and ROs is shown in FIG. 4. When N is 1, a mapping between SSBs and ROs is shown in FIG. 5. When N is 2, a mapping between SSBs and ROs is shown in FIG. 6. When N is 2, two consecutive SSB indexes evenly divide first total NumberOfRA-Preambles PRACH preambles in a single RO.

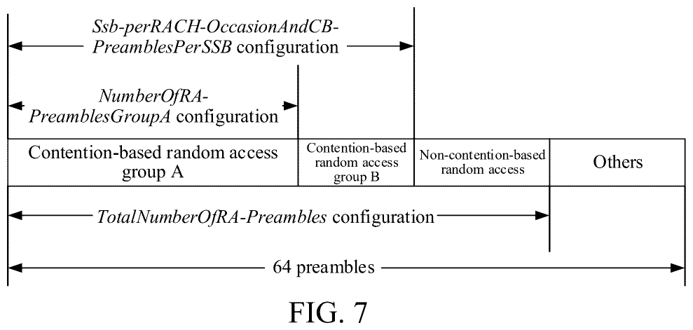

The terminal may determine, based on a pre-defined rule in the protocol, whether an RO is a valid RO. For a valid RO, a mapping relationship between this valid RO and an actually transmitted SSB index may be determined based on the above configuration of the parameter N. As shown in FIG. 7, when N<=1, this valid RO corresponds to a single SSB index, and first totalNumberOfRA-Preambles PRACH preambles of 64 PRACH preambles corresponding to this valid RO all correspond to the SSB index. Otherwise, the total NumberOfRA-Preambles PRACH preambles in this valid RO are evenly divided by the N SSB indexes (that is, the SSB indexes sequentially correspond to the totalNumberOfRA-Preambles/N PRACH preambles). When Random Access CHannel (RACH) resources corresponding to this valid RO may be used for contention-based random access, first R PRACH preambles in the PRACH preambles corresponding to each SSB index in this valid RO may be further configured for the contention-based random access.

The random access will be described in detail below.

In Rel-15 NR, a terminal needs to initiate a random access procedure in many scenarios. Generally, the random access procedure may be divided into a contention-based random access procedure and a non-contention-based random access procedure based on whether contention resolution needs to be performed.

A procedure of the contention-based random access procedure may be usually divided into four steps (also referred to as four-step random access):

First step: The terminal selects an RO and a preamble index to initiate a corresponding preamble transmission. The preamble transmission may also be referred to as a message (Message, Msg) 1 transmission, corresponding to a PRACH transmission in a physical layer.

Second step: The network side transmits, after detecting the corresponding preamble transmission, a corresponding Random Access Response (RAR) to notify the terminal of time-frequency resources for initiating an Msg3 transmission, and information such as TC-RNTI and TA command. The RAR transmission may also be referred to as Msg2 transmission, corresponding to PDSCH transmission in the physical layer.

Third step: The terminal initiates a corresponding Physical Uplink Shared CHannel (PUSCH) transmission based on information in the RAR. A TB carried in the PUSCH transmission carries a related identifier used for next step of contention resolution, for example, C-RNTI or CCCH SDU. The TB supports a Hybrid Automatic Repeat reQuest (HARQ) transmission. That is, when the network side does not successfully decode the RAR-based PUSCH transmission and correctly obtain the TB, retransmission for the TB may be further scheduled until the decoding is successful. Both the initial transmission and the retransmission of the TB may be referred to as Msg3 transmission, or may be respectively referred to as Msg3 initial transmission and Msg3 retransmission, and correspond to the PUSCH transmission in the physical layer.

Fourth step: After successfully decoding the Msg3, the network side may perform operations in the following two cases:

I. When the related identifier in the third step is the C-RNTI, as long as the terminal detects a Physical Downlink Control CHannel (PDCCH) scrambled by the C-RNTI, it is considered that the contention resolution is successful, and the random access successfully ends. In this case, the PDCCH may schedule normal data transmission and perform a conventional Hybrid Automatic Repeat reQuest ACKnowledgement (HARQ-ACK) feedback.

II. When the related identifier in the third step is the CCCH SDU, the network side may deliver a corresponding response message to be transmitted in a corresponding Physical Downlink Shared CHannel (PDSCH) in the physical layer, and carry the CCCH SDU in the response message as a contention resolution identifier. When the terminal successfully decodes the response message and detects that the contention resolution identifier in the response message matches the CCCH SDU transmitted by the terminal, it is considered that the contention resolution for the response message is successful, so that a corresponding HARQ-ACK (whose value is ACK) is fed back for the response message, and it is considered that the random access procedure successfully ends.

The PDCCH transmission in the above first case and the PDSCH transmission in the second case may be referred to as Msg4 transmission. The above HARQ-ACK feedback is carried by the PUCCH transmission in the physical layer.

For the above non-contention-based random access procedure, because the resources (including preamble indexes) corresponding to the preamble transmission initiated by the terminal in the above first step are usually notified by the network side in advance, in the above second step, after detecting the corresponding preamble transmission, the network side may determine the terminal initiating this random access procedure, so that the random access procedure includes only the above first step and second step.

However, in Rel-16, to improve efficiency of small data transmission, shorten a time delay of the random access procedure, lower a Listen Before Talk (LBT) demand of an unauthorized frequency band, and the like, two-step random access is introduced.

In some implementations, for the above contention-based random access procedure, a typical two-step random access procedure may be simply understood as:

(I) The first step and the third step of the above contention-based random access procedure are approximately combined into the first step. In this case, the first step is that the terminal initiates MsgA transmission, corresponding to PRACH transmission and PUSCH transmission mapped thereto in the physical layer.

(II) The second step and the fourth step of the above contention-based random access procedure are approximately combined into the second step. In this case, the second step is that after receiving the MsgA transmission, the network side delivers the corresponding MsgB transmission, and after successfully receiving the MsgB transmission and determining that the contention resolution is successful, the terminal executes the corresponding HARQ-ACK feedback.

For the above non-contention-based random access procedure, two steps of operations are similar to those of the above two steps, except that in this case, there is no contention resolution. The PUSCH transmission in the first step may carry user data that is not used for contention resolution. In the second step, there is no need to determine whether the contention resolution is successful. After receiving the MsgB transmission corresponding to the preamble transmission in the first step, the terminal may execute the corresponding HARQ-ACK feedback.

Currently, in a network in which SBFD features are deployed, many companies consider that it is possible to study a random access procedure that can use uplink resources in an uplink subband configured (or indicated) in semi-static downlink symbols or semi-static flexible symbols. However, there is still no solution to how to determine uplink resources specifically used in the random access procedure.

To solve the above problem, in the random access method provided in the embodiments of this application, the terminal may execute random access in a random access mode. The random access mode is used for determining the resources used in the target transmission, and the target transmission includes at least one of the following: a PRACH transmission corresponding to the random access and a target uplink transmission during a procedure of the random access. According to the solution, because the terminal may execute the random access in the random access mode for determining resources used by the target transmission corresponding to the random access, the terminal may determine, according to the random access mode, uplink resources specifically used in the random access procedure, thereby improving performance of the random access.

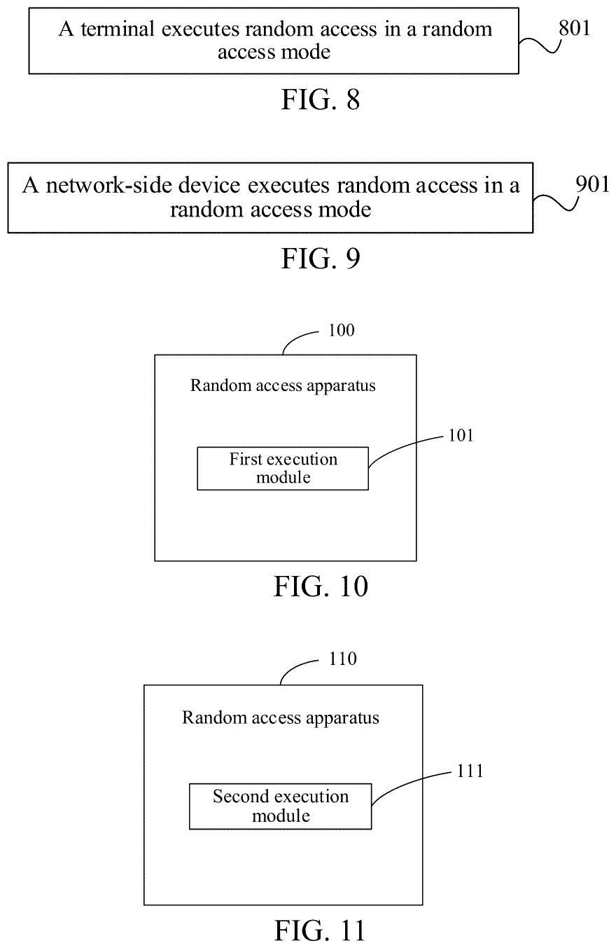

An embodiment of this application provides a random access method. FIG. 8 is a flowchart of a random access method according to an embodiment of this application. As shown in FIG. 8, the random access method according to the embodiment of this application may include step 801 as follows.

Step 801: Execute, by a terminal, random access in a random access mode.

The above random access mode is used for determining resources used by a target transmission, and the target transmission includes at least one of the following: a PRACH transmission corresponding to the above random access and a target uplink transmission during a procedure of the random access.

In some implementations, the above terminal may be a terminal supporting SBFD features.

In some implementations, the above executing, by a terminal, random access includes: transmitting, by the terminal, the above target transmission on determined resources. In some implementations, the above random access may be: four-step random access or two-step random access.

In some implementations, the above four-step random access may include: contention-based random access using four steps, or non-contention-based random access using four steps.

In some implementations, the above two-step random access may include: contention-based random access using two steps, or non-contention-based random access using two steps.

In some implementations, the above random access mode may include any one of 1.1 to 1.6 as follows:
1.1. both the above PRACH transmission and the above target uplink transmission only use resources in non-SBFD time units;
1.2. the above PRACH transmission only uses the resources in non-SBFD time units, and the above target uplink transmission is capable of using resources in SBFD time units;
1.3. the above PRACH transmission is capable of using the resources in SBFD time units, and the above target uplink transmission only uses the resources in the non-SBFD time unit;
1.4. both the above PRACH transmission and the above target uplink transmission are capable of using the resources in SBFD time units;
1.5. the above PRACH transmission only uses the resources in non-SBFD time units; and
1.6. the above PRACH transmission is capable of using the resources in SBFD time units.

In some implementations, time units may include: a slot, a sub-frame, a symbol, a sub-slot, or a radio frame.

In the embodiment of this application, because the above random access mode may include any one of the above 1.1 to 1.6, the flexibility of the terminal in executing the above random access may be improved.

In some implementations, the above random access is four-step random access. Then, the above PRACH transmission may correspond to an Msg1 transmission during the above random access. The above target uplink transmission may include at least one of the following:
a PUSCH transmission used for carrying an Msg3; and
a physical uplink control channel (Physical Uplink Control Channel, PUCCH) transmission used for carrying a first HARQ-ACK feedback, where the first HARQ-ACK feedback is an HARQ-ACK feedback corresponding to an Msg4.

It should be noted that when the above four-step random access is the above non-contention-based random access using four steps, the above random access procedure does not involve another uplink transmission (that is, the above target uplink transmission) than the above PRACH transmission. In this case, the above random access mode may include the above 1.5 or 1.6.

In the embodiment of this application, because when the above random access is the four-step random access, the above random access mode may be used for determining resources used by at least one of an Msg1 transmission, a PUSCH transmission used for carrying an Msg3, and a PUCCH transmission used for carrying a first HARQ-ACK feedback, flexibility and effectiveness of determining the uplink resources can be improved.

In some implementations, the above random access is two-step random access. Then, the above PRACH transmission may correspond to (or be subordinate to) an MsgA transmission during the above random access. The above target uplink transmission may include at least one of the following:
a PUSCH transmission corresponding to the above MsgA transmission; and
a PUCCH transmission used for carrying a second HARQ-ACK feedback, where the second HARQ-ACK feedback is an HARQ-ACK feedback corresponding to an MsgB.

In the embodiment of this application, because when the above random access is the two-step random access, the above random access mode may be used for determining resources used by at least one of an MsgA transmission, a PUSCH transmission corresponding to the MsgA transmission, and a PUCCH transmission used for carrying the second HARQ-ACK feedback, flexibility and effectiveness of determining the uplink resources can be further improved.

For specific descriptions of the above Msg1, Msg3, Msg4, MsgA, and MsgB, reference may be made to related descriptions in the above related art. To avoid repetition, details are not described herein again.

In some implementations, the resources in the above SBFD time units capable of being used by the above PRACH transmission may include: resources corresponding to first ROs.

The above first ROs are ROs mapped in an uplink subband in the above SBFD time units.

In the embodiment of this application, because the resources in the above SBFD time units capable of being used by the above PRACH transmission may include the resources corresponding to the above first ROs, flexibility and effectiveness of determining the resources capable of being used by the above PRACH transmission can be improved.

In some implementations, the resources corresponding to the above first ROs may be configured in an RO resource configuration mode. The RO resource configuration mode may include any one of A and B as follows:
A: an SBFD RO resource configuration mode without introducing an additional PRACH configuration; and
B: an SBFD RO resource configuration mode with introducing an additional PRACH configuration.

The above additional PRACH configuration may include at least one of the following: a PRACH configuration used for contention-based random access and a PRACH configuration used for non-contention-based random access.

In some implementations, when the above RO resource configuration mode includes the above A, the resources corresponding to the above first ROs may use only the PRACH configuration involved in the existing protocol, including at least one of the following: a common PRACH configuration, a dedicated PRACH configuration, a beam failure recovery PRACH configuration, and a system information PRACH configuration.

In some implementations, the above common PRACH configuration is configured by a high-level parameter BWP-UplinkCommon→rach-ConfigCommon→prach-ConfigurationIndex, and the corresponding RACH resources may be used for both the contention-based random access and the non-contention-based random access.

In some implementations, the above dedicated PRACH configuration is configured by a high-level parameter ReconfigurationWithSync→rach-ConfigDedicated→cfra→prach-ConfigurationIndex, and the corresponding RACH resources may be used only for the non-contention-based random access.

In some implementations, the above beam failure recovery PRACH configuration is configured by a high-level parameter BWP-UplinkDedicated→beamFailureRecoveryConfig→rach-ConfigBFR→prach-ConfigurationIndex, and the corresponding RACH resources may be used only for the non-contention-based random access.

In some implementations, the above system information PRACH configuration is configured high-level parameter SI-SchedulingInfo→si-RequestConfig(/si-RequestConfigSUL)→rach-OccasionsSI→prach-ConfigurationIndex, and the corresponding RACH resources may be used only for the non-contention-based random access.

In some implementations, the above additional PRACH configuration may be additionally configured based on the PRACH configuration involved in the above existing protocol.

In some implementations, for at least one of the PRACH configurations involved in the above existing protocol, a corresponding PRACH configuration using the RACH resources in SBFD time units may be separately configured for each of the at least one PRACH configuration. Two PRACH configurations corresponding to each other may be applied to a same system function, for example, beam failure recovery and system information request.

In some implementations, the introduction of the above additional PRACH configuration is to use the uplink resources in SBFD time units for the PRACH transmission.

In some implementations, a mapping between ROs and SSBs may be determined for each additional PRACH configuration.

In some implementations, the above terminal may use RACH resources corresponding to at least one of the PRACH configuration involved in the above existing protocol and the above additional PRACH configuration.

In some implementations, for the above RO resource configuration mode A:
for the above common PRACH configuration, whether the RACH resources corresponding to the corresponding second valid ROs can be used for the contention-based random access or the non-contention-based random access may be specified by a protocol or configured by high-level signaling; and
for the above dedicated PRACH configuration/beam failure recovery PRACH configuration/system information PRACH configuration, whether the RACH resources corresponding to the corresponding second valid ROs can be used for the non-contention-based random access may be specified by a protocol or configured by high-level signaling.

In some implementations, for the above RO resource configuration mode B, whether to introduce additional RACH resources may be controlled by configuring the above additional PRACH configuration:
for the above common PRACH configuration, when the corresponding additional PRACH configuration is not configured, no additional RACH resources are introduced for the SBFD; and when the corresponding additional PRACH configuration is configured, whether the RACH resources corresponding to the corresponding additional PRACH configuration can be used for the contention-based random access or the non-contention-based random access may be specified by a protocol or configured by high-level signaling; and
for the above dedicated PRACH configuration/beam failure recovery PRACH configuration/system information PRACH configuration, when the corresponding additional PRACH configuration is not configured, no additional RACH resources are introduced for the SBFD; and when the corresponding additional PRACH configuration is configured, the RACH resources corresponding to the additional PRACH configuration are directly used for the non-contention-based random access.

A specific method for determining the mapping between ROs and SSBs by the terminal will be described in detail in the following embodiment. To avoid repetition, details are not described herein again.

In the embodiment of this application, because the resources corresponding to the above first ROs may be configured in any one of the above RO resource configuration modes, flexibility of configuring the resources corresponding to the first ROs can be improved.

In some implementations, the resources in the above SBFD time units capable of being used by a PUSCH transmission included in the above target uplink transmission may include: resources corresponding to first PUSCH Occasion (PO).

The above first POs are POs mapped in an uplink subband in the above SBFD time units.

In some implementations, the resources corresponding to the above first POs may be configured in a PO resource configuration mode.

It should be noted that, the embodiment of this application is described in an example where the above PO resource configuration mode is an SBFD PO resource configuration mode without introducing an additional PUSCH resource configuration. During actual implementation, the PO resource configuration mode may alternatively be an SBFD PO resource configuration mode with introducing an additional PUSCH resource configuration, that is, configuring an additional PUSCH resource configuration for SBFD time units. This is not limited in the embodiment of this application.

In the embodiment of this application, because the resources in the above SBFD time units capable of being used by the PUSCH transmission included in the above target uplink transmission may include the resources corresponding to the first POs, flexibility of determining the resources capable of being used by the above PUSCH transmission can be improved.

In some implementations, the above random access mode satisfies: the above PRACH transmission only uses the resources in non-SBFD time units, and the target uplink transmission is capable of using the resources in SBFD time units.

Configuration of SBFD notification RACH resources corresponding to the above random access may include at least one of the following:
ROs used for an SBFD notification; and
PRACH preambles used for the SBFD notification.

In some implementations, when a single SSB is mapped to a plurality of consecutive valid ROs, M ROs at predefined locations in the plurality of valid ROs may be used for the above SBFD notification. The predefined locations may be the beginning/end, or may be other locations specified by a protocol, or may be any location configured by high-level signaling. M may be specified by a protocol or configured by high-level signaling.

In some implementations, all the PRACH preambles corresponding to any one of the above M ROs may be used for the SBFD notification, or when the PRACH preambles for the SBFD notification are configured at the same time, the PRACH preambles corresponding to any one of the above M ROs may be used for the SBFD notification.

In some implementations, for a valid RO, N PRACH preambles at predefined locations in the corresponding PRACH preambles may be used for the SBFD notification.

In some implementations, N PRACH preambles at predefined locations in the R (number of contention based preambles per SS/PBCH block per valid PRACH occasion) PRACH preambles of the above valid RO may be used for the SBFD notification. When the R PRACH preambles are further divided into a contention-based random access group A and a contention-based random access group B, the N PRACH preambles at the predefined positions may be used for the SBFD notification (alternatively, at this time, N1 and N2 may be further determined (N=N1+N2), and N1 PRACH preambles at predefined locations in the contention-based random access group A and N2 PRACH preambles at predefined locations in the contention-based random access group B may be used for the SBFD notification respectively, where N1 and N2 may be specified by a protocol or configured by high-level signaling). The predefined locations may be the beginning/end, or other locations specified by a protocol, or any locations configured by high-level signaling. N may be specified by a protocol or configured by high-level signaling.

In some implementations, the above valid RO may be any valid RO corresponding to an existing PRACH configuration (for example, a common PRACH configuration). Alternatively, when ROs or an RO subset used for the SBFD notification is configured at the same time, the above valid RO is any valid RO in the configured ROs or RO subset.

In some implementations, if the terminal already learns that the current serving cell supports SBFD operations and already further learns the above SBFD notification RACH resources, the terminal may select an appropriate SSB/PRACH preamble/RO to notify the network device based on the SBFD notification RACH resources and an existing rule. Therefore, after the network device detects the PRACH preamble transmission corresponding to the SBFD notification RACH resources, the network device may schedule, based on an implementation policy, a resource availability situation, and the like, another subsequent uplink transmission. The another uplink transmission is allowed to use the resources in SBFD time units, but specifically whether the another uplink transmission is located in SBFD time units or overlaps with SBFD time units in a time domain may be determined based on network side implementation. This is not limited in the embodiment of this application.

In the embodiment of this application, when the above random access mode satisfies the above 1.2, the configuration of the SBFD notification RACH resources corresponding to the above random access may include at least one of an RO used for the SBFD notification and a RACH preamble used for the SBFD notification. Therefore, flexibility of configuring the SBFD notification RACH resources can be improved.

In some implementations, the above random access mode satisfies: the above PRACH transmission only uses the resources in non-SBFD time units, and the target uplink transmission is capable of using the resources in SBFD time units. Then, in a case that the target uplink transmission only includes a first uplink transmission, the above terminal is capable of transmitting a notification message to the network device by using the second uplink transmission.

In the embodiment of this application, the above first uplink transmission may include at least one of the following: a PUCCH transmission used for carrying a first HARQ-ACK feedback, where the first HARQ-ACK feedback is an HARQ-ACK feedback corresponding to an Msg4; and a PUCCH transmission used for carrying a second HARQ-ACK feedback, where the second HARQ-ACK feedback is an HARQ-ACK feedback corresponding to an MsgB.

In the embodiment of this application, the above second uplink transmission may include at least one of the following: a PUSCH transmission used for carrying an Msg3; and a PUSCH transmission corresponding to an MsgA transmission.

In the embodiment of this application, the above notification message is used for notifying the above network device of any one of the following: the above terminal is an SBFD terminal; and it is expected that an uplink transmission after the above second uplink transmission is capable of using the resources in the above SBFD time units.

In some implementations, the above notification message may be carried in any one of the following modes:
including the above notification message in a CCCH SDU carried in a Transport Block (TB) carried by the PUSCH transmission, for example, adding a corresponding cell;
encapsulating a corresponding media access control unit, used for carrying the above notification message, in the TB carried by the PUSCH transmission; and
carrying the above notification message during TB processing of a PHY layer, for example, when cyclic redundancy check bits are generated, superimposing (for example, adding bit by bit and modulo 2) a particular bit sequence, used for indicating the above notification message, to the generated cyclic redundancy check bits.

In the embodiment of this application, when the above random access mode satisfies the above 1.2, in a case that the above target uplink transmission only includes the above first uplink transmission, the above terminal is capable of transmitting a notification message to a network device by using the above second uplink transmission, to notify the network device that the terminal is an SBFD terminal or it is expected that an uplink transmission after the second uplink transmission is capable of using the resources in the above SBFD time units. Therefore, a function of random access can be enriched.

In the random access method according to the embodiment of this application, the terminal may execute the random access based on the resources used by the target transmission corresponding to the random access determined by using the random access mode. Therefore, uplink resources in an uplink subband can be flexibly determined and effectively used, thereby improving performance such as a time delay and a capacity of the random access.

A specific method for determining the mapping between ROs and SSBs by the terminal will be described in detail below.

In some implementations, the above RO resource configuration mode includes: the above SBFD RO resource configuration mode without introducing an additional PRACH configuration. Then, before the above step 801, the random access method according to the embodiment of this application may further include step 802 as follows.

Step 802: Determine, by the terminal, a first mapping between ROs and SSBs based on an RO mapping mode.

In the embodiment of this application, the above RO mapping mode may include at least one of the following:
a mode of uniformly mapping first valid ROs and second valid ROs to the SSBs; and
a mode of respectively mapping the first valid ROs and the second valid ROs to the SSBs.

The above first valid ROs are valid ROs that are determined based on a first determining rule. The above second valid ROs are valid ROs that are determined based on a second determining rule and are not any of the first valid ROs. The first determining rule is different from the second determining rule.

A specific method of determining, by the above terminal, the above first mapping based on the above mode of uniformly mapping the first valid ROs and the second valid ROs to the SSBs and based on the above mode of respectively mapping the first valid ROs and the second valid ROs to the SSBs will be described in detail in the following embodiment. To avoid repetition, details are not described herein again.

In some implementations, the first determining rule may be an existing determining rule. That is, it is assumed that a network in which SBFD features are deployed always operates in a non-pairwise spectrum and tdd-UL-DL-ConfigurationCommon is always configured for each cell, then when the entire RO is located in semi-static uplink time units, the RO is determined as a valid RO. Otherwise, when the RO is not located before SSB time units in the PRACH slot and starts after at least N_ gap time units of any semi-static downlink time units or SSB time units, the RO is determined as a valid RO. The N_gap here is an integer, which may be determined by a protocol or configured by high-level signaling.

In the embodiment of this application, when the above RO resource configuration mode includes the above SBFD RO resource configuration mode without introducing an additional PRACH configuration, the terminal may determine the above first mapping based on any one of the above RO mapping modes, so flexibility of determining the mapping between ROs and SSBs can be improved.

In some implementations, the above second determining rule may include:
determining that the RO is a valid RO if the RO is entirely located in semi-static uplink time units; and
determining that the RO is a valid RO if the RO overlaps with at least one non-semi-static uplink time unit in time domain and the RO meets a first preset condition.

The above first preset condition may include at least one of 2.1 to 2.3 as follows:

2.1. No conflict with SSB time units.

In some implementations, it is considered that the RO conflicts with SSB time units when at least one of the following is met:
time-frequency resources of the RO and SSB time units overlap;
the RO and SSB time units overlap in a time domain, but do not overlap in a frequency domain;
N_gap time units before the RO and SSB time units overlap in a time domain; and
the RO is located before SSB time units of one PRACH slot.

2.2. No conflict with semi-static downlink time units.

In some implementations, it is considered that the RO conflicts with semi-static downlink time units when at least one of the following is met:
semi-static downlink time units are determined as non-SBFD time units based on a configuration/indication, and the RO overlaps with semi-static downlink time units in a time domain;
semi-static downlink time units are determined as non-SBFD time units based on a configuration/indication, and N_gap symbols before the RO overlap with semi-static downlink time units in a time domain;
semi-static downlink time units are determined as SBFD time units based on a configuration/indication, and the RO overlaps with semi-static downlink time units in a time domain;
semi-static downlink time units are determined as SBFD time units based on a configuration/indication, the RO overlaps with semi-static downlink time units in a time domain, and at the overlap in the time domain, the RO overlaps with a downlink subband and/or a guard band in a frequency domain; and
semi-static downlink time units are determined as SBFD time units based on a configuration/indication, and N_gap symbols before the RO overlap with semi-static downlink time units in a time domain.

2.3. No conflict with semi-static flexible time units.

In some implementations, it is considered that the RO conflicts with semi-static flexible time units when at least one of the following is met:
semi-static flexible time units are determined as SBFD time units based on a configuration/indication, and the RO overlaps with semi-static flexible time units in a time domain;
semi-static flexible time units are determined as SBFD time units based on a configuration/indication, the RO overlaps with semi-static flexible time units in a time domain, and at the overlap in the time domain, the RO overlaps with a downlink subband and/or a guard band in a frequency domain; and
semi-static flexible time units are determined as SBFD time units based on a configuration/indication, and N_gap symbols before the RO overlap with semi-static flexible time units in a time domain.

In some implementations, the above semi-static downlink time units/semi-static flexible time units may be determined as non-SBFD time units/SBFD time units based on a configuration/indication.

In some implementations, semi-static downlink time units/semi-static flexible time units may be determined based on configuration of a high-level parameter tdd-UL-DL-ConfigurationCommon.

In some implementations, whether they are non-SBFD time units/SBFD time units may be determined based on semi-static configuration information.

In some implementations, whether they are non-SBFD time units/SBFD time units may be further determined based on dynamic overriding (that is, dynamic overriding, for example, scheduling of DCI, SFI, or a dedicated DCI indication).

In some implementations, when PRACH resources or contention-based PRACH resources are configured in uplink resources in semi-statically configured SBFD time units, SBFD time units are not allowed to be changed by the above dynamic overriding into non-SBFD time units.

In some implementations, cell-specific common PDCCH in new SIB information or common CORESET may enable/disable PRACH resources in SBFD time units.

In the embodiment of this application, the above second determining rule may include: determining that the RO is a valid RO if the RO is entirely located in semi-static uplink time units; and determining that the RO is a valid RO if the RO overlaps with at least one non-semi-static uplink time unit in time domain and the RO meets a first preset condition. Therefore, based on the existing determining rule, a probability that the RO is determined as a valid RO can be increased, so that a quantity of valid ROs can be increased, and resources used in random access can be enriched.

In some implementations, the above RO mapping mode includes: the above mode of uniformly mapping first valid ROs and second valid ROs to the SSBs. Then, the above step 802 may be specifically implemented by using step 802a as follows.

Step 802a: Determine, by the terminal, the first mapping according to a first RO set.

The above first RO set includes the above first valid ROs and the above second valid ROs.

In some implementations, the terminal may determine the above first mapping based on the first RO set and an existing rule.

The above existing rule may follow a corresponding description in an existing specification. For example, when determining the first mapping, for the mapped SSBs, only SSBs corresponding to the SSB index determined by the high-level parameter SIB1 or the parameter ssb-PositionsInBurst in ServingCellConfigCommon are considered. When mapping POs and/or PRACH preambles to the SSBs, first, the PRACH preamble corresponding to a same PO are traversed based on an ascending order of preamble indexes; second, POs for frequency division multiplexing are traversed based on an ascending order of frequency domain indexes; then, POs for time division multiplexing in a same PRACH slot are traversed based on an ascending order of time domain indexes; and finally, PRACH slots that appear successively on the time axis are traversed based on an increasing order of time domain indexes.

In the embodiment of this application, because the terminal can determine the above first mapping based on the above first RO set, flexibility of determining the first mapping can be improved.

In some implementations, the above RO mapping mode includes: the above mode of respectively mapping the first valid ROs and the second valid ROs to the SSBs. The above first mapping includes a first sub-mapping and a second sub-mapping. Then, the above step 802 may be specifically implemented by using step 802b and step 802c as follows.

Step 802b: Determine, by the terminal, the first sub-mapping according to the first valid ROs.

Step 802c: Determine, by the terminal, the second sub-mapping according to the second valid ROs.

In some implementations, the above terminal may use RACH resources corresponding to at least one of the above first sub-mapping and second sub-mapping.

In some implementations, when the SBFD terminal may use the RACH resources corresponding to the above first sub-mapping and second sub-mapping at the same time, compared with a legacy terminal (that is, a terminal that does not support the SBFD features or a terminal that supports only the NR basic features), the SBFD terminal may use more RACH resources (that is, may additionally use the RACH resources corresponding to the second sub-mapping), thereby improving the RACH capacity and reducing the collision probability.

In some implementations, when the SBFD terminal only uses the RACH resources corresponding to the above first sub-mapping, available RACH resources and RACH performance are the same as those of the legacy terminal.

In some implementations, when the SBFD terminal only uses the RACH resources corresponding to the above second sub-mapping, the SBFD terminal and the legacy terminal use orthogonal RACH resources. In this case, the RACH resources corresponding to the existing PRACH configuration are actually divided into two groups, and each group separately corresponds to the legacy terminal or the SBFD terminal.

In some implementations, the RACH resources capable of being used by the SBFD terminal may be specified by a protocol or configured by high-level signaling.

It should be noted that the legacy terminal and the SBFD terminal have the same understanding of the above first sub-mapping.

In some implementations, the SBFD terminal that only uses the RACH resources corresponding to the above second sub-mapping determines all the first valid ROs as invalid ROs. In this case, the SBFD terminal does not need to determine or use the first sub-mapping.

In the embodiment of this application, because the terminal can determine the above first sub-mapping according to the above first valid ROs and determine the above second sub-mapping according to the above second valid ROs, flexibility of determining the first mapping can be further improved.

A specific method for determining the mapping between ROs and POs by the terminal will be described in detail below.

In some implementations, before the above step 801, the random access method provided in the embodiment of this application may further include step 803 as follows.

Step 803: Determine, by the terminal, a second mapping between ROs and POs based on a PO mapping mode.

In the embodiment of this application, the above PO mapping mode includes any one of C and D as follows:
C: a mode of uniformly mapping a valid PO set and a second RO set, where the valid PO set includes first valid POs and second valid POs, and the second RO set includes first valid ROs and second valid ROs, or the first valid ROs; and
D: a mode of mapping the first valid POs and the first valid ROs and mapping the second valid POs and target valid ROs, where the target valid ROs are the first valid ROs or the above second valid ROs.

The above first valid ROs are valid ROs that are determined based on a first determining rule. The above second valid ROs are valid ROs that are determined based on a second determining rule and do not include a valid RO in the first valid ROs. The first determining rule is different from the second determining rule.

The above first valid POs are valid POs that are determined based on a third determining rule. The above second valid POs are valid POs that are determined based on a fourth determining rule and do not include a valid PO in the first valid POs. The third determining rule is different from the fourth determining rule.

After the POs or the PO set, and the ROs or the RO set are determined, for the mapping between ROs and POs, reference may be made to an existing mode. For details, reference may be made to descriptions in related specifications.

In some implementations, when the above PO mapping mode includes the above C, if the above second valid ROs exist, the above second RO set includes the above first valid ROs and the second valid ROs; and if the second valid ROs do not exist, the second RO set includes the first valid ROs.

In some implementations, when the above PO mapping mode includes the above D, if the above second valid ROs exist, the above target valid ROs are the second valid ROs; and if the second valid ROs do not exist, the target valid ROs are the above first valid ROs.

In the embodiment of this application, because the terminal may determine the above second mapping based on any one of the above PO mapping modes, flexibility of determining the mapping between ROs and POs can be improved.

In some implementations, the above fourth determining rule may include:
determining that a PO is a valid PO if the entire PO is located in semi-static uplink time units and the PO does not overlap with any third valid ROs in a time domain and a frequency domain; and
determining that a PO is a valid PO if the PO overlaps with at least one non-semi-static uplink time unit in time domain, the PO does not overlap with any third valid RO in time domain and frequency domain, and the PO meets a second preset condition.

The above third valid ROs include at least one of the above first valid ROs and the above second valid ROs. The above second preset condition may include at least one of the following:
no conflict with SSB time units;
no conflict with semi-static downlink time units; and
no conflict with semi-static flexible time units.

It should be noted that the above second preset condition is a condition that the POs need to meet. For details, reference may be made to related descriptions in the above first preset condition, and only the ROs need to be replaced with the POs.

In the embodiment of this application, because the above fourth determining rule may include: determining that a PO is a valid PO if the entire PO is located in semi-static uplink time units and the PO does not overlap with any third valid ROs in a time domain and a frequency domain; and determining that a PO is a valid PO if the PO overlaps with at least one non-semi-static uplink time unit in time domain, the PO does not overlap with any third valid RO in time domain and frequency domain, and the PO meets a second preset condition. Therefore, based on the existing determining rule, a probability that the PO is determined as a valid PO can be increased, so that a quantity of valid POs can be increased, and resources used in random access can be enriched.

In some implementations, the above PO mapping mode includes: the above mode of uniformly mapping a valid PO set and a second RO set. Then, the above step 803 may be specifically implemented by using step 803a as follows.

Step 803a: Map, by the terminal, the valid PO set and the second RO set to determine the second mapping.

In some implementations, the terminal may map, according to an existing rule, the above valid PO set and the above second RO set to determine the above second mapping.

In the embodiment of this application, because the terminal may map the above valid PO set and the above second RO set to determine the above second mapping, flexibility of determining the second mapping can be improved.

In some implementations, the above PO mapping mode includes: the above mode of mapping the first valid POs and the first valid ROs and mapping the second valid POs and target valid ROs. The above second mapping includes a third sub-mapping and a fourth sub-mapping. Then, the above step 803 may be specifically implemented by using step 803b and step 803c as follows.

Step 803b: Map, by the terminal, the first valid POs and the first valid ROs to determine the third sub-mapping.

Step 803c: Map, by the terminal, the second valid POs and the second valid ROs to determine the fourth sub-mapping.

In the embodiment of this application, the terminal may map the above first valid POs and the above first valid ROs to determine the above third sub-mapping and map the above second valid POs and the above second valid ROs to determine the above fourth sub-mapping. Therefore, flexibility of determining the second mapping can be further improved.

For other descriptions of the method for determining the mapping between ROs and POs by the terminal, reference may be made to the related descriptions of determining the mapping between ROs and SSBs by the terminal in the above embodiment. To avoid repetition, details are not described herein again.

An embodiment of this application provides another random access method. FIG. 9 is a flowchart of a random access method according to an embodiment of this application. As shown in FIG. 9, the random access method according to the embodiment of this application may include step 901 as follows.

Step 901: Execute, by a network device, random access in a random access mode.

The above random access mode is used for determining resources used by a target transmission, and the target transmission includes at least one of the following: a PRACH transmission corresponding to the above random access and a target uplink transmission during a procedure of the random access.

In some implementations, the above executing, by a network device, random access includes: receiving, by the network device, the above target transmission on determined resources.

In some implementations, the above random access mode may include any one of the following:
both the above PRACH transmission and the above target uplink transmission only use resources in non-SBFD time units;
the above PRACH transmission only uses the resources in non-SBFD time units, and the above target uplink transmission is capable of using resources in SBFD time units;
the above PRACH transmission is capable of using the resources in SBFD time units, and the above target uplink transmission only uses the resources in non-SBFD time units;
both the above PRACH transmission and the above target uplink transmission are capable of using the resources in SBFD time units;
the above PRACH transmission only uses the resources in non-SBFD time units; and
the above PRACH transmission is capable of using the resources in SBFD time units.

In some implementations, the above random access is four-step random access. Then, the above PRACH transmission may correspond to an Msg1 transmission during the above random access. The above target uplink transmission may include at least one of the following:
a PUSCH transmission used for carrying an Msg3; and
a PUCCH transmission used for carrying a first HARQ-ACK feedback, where the first HARQ-ACK feedback is an HARQ-ACK feedback corresponding to an Msg4.

In some implementations, the above random access is two-step random access. Then, the above PRACH transmission may correspond to an MsgA transmission during the above random access. The above target uplink transmission may include at least one of the following:
a PUSCH transmission corresponding to the above MsgA transmission; and
a PUCCH transmission used for carrying a second HARQ-ACK feedback, where the second HARQ-ACK feedback is an HARQ-ACK feedback corresponding to an MsgB.

In some implementations, the resources in the above SBFD time units capable of being used by the above PRACH transmission may include: resources corresponding to first ROs.

The above first ROs are ROs mapped in an uplink subband in the above SBFD time units.

In some implementations, the resources corresponding to the above first ROs may be configured according to an RO resource configuration mode. The RO resource configuration mode may include any one of the following:
an SBFD RO resource configuration mode without introducing an additional PRACH configuration; and
an SBFD RO resource configuration mode with introducing an additional PRACH configuration.

The above additional PRACH configuration may include at least one of the following: a PRACH configuration used for contention-based random access and a PRACH configuration used for non-contention-based random access.

In some implementations, the resources in the above SBFD time units capable of being used by the PUSCH transmission included in the above target uplink transmission may include: resources corresponding to first POs.

The above first POs are POs mapped in an uplink subband in the above SBFD time units.

In some implementations, the above random access mode satisfies: the above PRACH transmission only uses the resources in non-SBFD time units, and the target uplink transmission is capable of using the resources in SBFD time units.

Configuration of SBFD notification RACH resources corresponding to the above random access may include at least one of the following:
ROs used for an SBFD notification; and
PRACH preambles used for the SBFD notification.

In some implementations, the above random access mode satisfies: the above PRACH transmission only uses the resources in non-SBFD time units, and the target uplink transmission is capable of using the resources in SBFD time units. Then, in a case that the target uplink transmission only includes the first uplink transmission, the above network device is capable of receiving a notification message transmitted by the terminal by using a second uplink transmission.

In the embodiment of this application, the above first uplink transmission may include at least one of the following: a PUCCH transmission used for carrying a first HARQ-ACK feedback, where the first HARQ-ACK feedback is an HARQ-ACK feedback corresponding to an Msg4; and a PUCCH transmission used for carrying a second HARQ-ACK feedback, where the second HARQ-ACK feedback is an HARQ-ACK feedback corresponding to an MsgB.

In the embodiment of this application, the above second uplink transmission may include at least one of the following: a PUSCH transmission used for carrying an Msg3; and a PUSCH transmission corresponding to an MsgA transmission.

In the embodiment of this application, the above notification message is used for notifying the above network device of any one of the following: the above terminal is an SBFD terminal; and it is expected that an uplink transmission after the above second uplink transmission is capable of using the resources in the above SBFD time units.

In the random access method according to the embodiment of this application, the network device may execute the random access based on the resources used by the target transmission corresponding to the random access determined by using the random access mode. Therefore, uplink resources in an uplink subband can be flexibly determined and effectively used, thereby improving performance such as a time delay and a capacity of the random access.

In some implementations, the above RO resource configuration mode includes: the above SBFD RO resource configuration mode without introducing an additional PRACH configuration. Then, before the above step 901, the random access method according to the embodiment of this application may further include step 902 as follows.

Step 902: Determine, by the network device, a first mapping between ROs and SSBs based on an RO mapping mode.

In the embodiment of this application, the above RO mapping mode may include at least one of the following:
a mode of uniformly mapping first valid ROs and second valid ROs to the SSBs; and
a mode of respectively mapping the first valid ROs and the second valid ROs to the SSBs.

The above first valid ROs are valid ROs that are determined based on a first determining rule. The above second valid ROs are valid ROs that are determined based on a second determining rule and do not include a valid RO in the first valid ROs. The first determining rule is different from the second determining rule.

In some implementations, the above second determining rule may include:
determining that the RO is a valid RO if the RO is entirely located in semi-static uplink time units; and
determining that the RO is a valid RO if the RO overlaps with at least one non-semi-static uplink time unit in time domain and the RO meets a first preset condition.

The above first preset condition may include at least one of the following:
no conflict with SSB time units;
no conflict with semi-static downlink time units; and
no conflict with semi-static flexible time units.

In some implementations, the above RO mapping mode includes: the above mode of uniformly mapping first valid ROs and second valid ROs to the SSBs. Then, the above step 902 may be specifically implemented by using step 902a as follows.

Step 902a: Determine, by the network device, the first mapping according to a first RO set.

The above first RO set includes the above first valid ROs and the above second valid ROs.

In some implementations, the above RO mapping mode includes: the above mode of respectively mapping the first valid ROs and the second valid ROs to the SSBs. The above first mapping includes a first sub-mapping and a second sub-mapping. Then, the above step 902 may be specifically implemented by using step 902b and step 902c as follows.

Step 902b: Determine, by the network device, the first sub-mapping according to the first valid ROs.

Step 902c: Determine, by the network device, the second sub-mapping according to the second valid ROs.

In some implementations, before the above step 901, the random access method provided in the embodiment of this application may further include step 903 as follows.

Step 903: Determine, by the network device, a second mapping between ROs and POs based on a PO mapping mode.

In the embodiment of this application, the above PO mapping mode may include at least one of the following:
a mode of uniformly mapping a valid PO set and a second RO set, where the valid PO set includes first valid POs and second valid POs, and the second RO set includes first valid ROs and second valid ROs, or the first valid ROs; and
a mode of mapping the first valid POs and the first valid ROs and mapping the second valid POs and target valid ROs, where the target valid ROs are the first valid ROs or the above second valid ROs.

The above first valid ROs are valid ROs that are determined based on a first determining rule. The above second valid ROs are valid ROs that are determined based on a second determining rule and do not include a valid RO in the first valid ROs. The first determining rule is different from the second determining rule.

The above first valid POs are valid POs that are determined based on a third determining rule. The above second valid POs are valid POs that are determined based on a fourth determining rule and do not include a valid PO in the first valid POs. The third determining rule is different from the fourth determining rule.

In some implementations, the above fourth determining rule may include:
determining that a PO is a valid PO if the entire PO is located in semi-static uplink time units and the PO does not overlap with any third valid ROs in a time domain and a frequency domain; and
determining that a PO is a valid PO if the PO overlaps with at least one non-semi-static uplink time unit in time domain, the PO does not overlap with any third valid RO in time domain and frequency domain, and the PO meets a second preset condition.

The above third valid ROs include at least one of the above first valid ROs and the above second valid ROs. The above second preset condition may include at least one of the following:
no conflict with SSB time units;
no conflict with semi-static downlink time units; and
no conflict with semi-static flexible time units.

In some implementations, the above PO mapping mode includes: the above mode of uniformly mapping a valid PO set and a second RO set. Then, the above step 903 may be specifically implemented by using step 903a as follows.

Step 903a: Map, by the network device, the valid PO set and the second RO set to determine the second mapping.

In some implementations, the above PO mapping mode includes: the above mode of mapping the first valid POs and the first valid ROs and mapping the second valid POs and target valid ROs. The above second mapping includes a third sub-mapping and a fourth sub-mapping. Then, the above step 903 may be specifically implemented by using step 903b and step 903c as follows.

Step 903b: Map, by the network device, the first valid POs and the first valid ROs to determine the third sub-mapping.

Step 903c: Map, by the network device, the second valid POs and the second valid ROs to determine the fourth sub-mapping.

For other descriptions in the embodiment of this application and technical effects that can be achieved by the technical features, reference may be made to the related descriptions in the above method embodiment on the terminal side. To avoid repetition, details are not described herein again.

An entity executing the random access method provided in the embodiments of this application may be a random access apparatus. In the embodiment of this application, the random access apparatus according to the embodiment of this application will be described in an example in which the random access apparatus executes the random access method.

With reference to FIG. 10, an embodiment of this application provides a random access apparatus 100. The random access apparatus 100 may include a first execution module 101. The first execution module 101 may be configured to execute random access in a random access mode. The random access mode is used for determining resources used by a target transmission, and the target transmission includes at least one of the following: a PRACH transmission corresponding to the random access and a target uplink transmission during a procedure of the random access.

In some implementations, the above random access mode may include any one of the following: both the above PRACH transmission and the above target uplink transmission only use resources in non-SBFD time units; the PRACH transmission only uses the resources in non-SBFD time units, and the target uplink transmission is capable of using resources in SBFD time units; the PRACH transmission is capable of using the resources in SBFD time units, and the target uplink transmission only uses the resources in non-SBFD time units; both the PRACH transmission and the target uplink transmission are capable of using the resources in SBFD time units; the PRACH transmission only uses the resources in non-SBFD time units; and the PRACH transmission is capable of using the resources in SBFD time units.

In some implementations, the above random access may be four-step random access. The above PRACH transmission may correspond to an Msg1 transmission during the above random access. The above target uplink transmission may include at least one of the following: a PUSCH transmission used for carrying an Msg3; and a PUCCH transmission used for carrying a first HARQ-ACK feedback, where the first HARQ-ACK feedback is an HARQ-ACK feedback corresponding to an Msg4.

In some implementations, the above random access is two-step random access. The above PRACH transmission may correspond to an MsgA transmission during the above random access. The above target uplink transmission may include at least one of the following: a PUSCH transmission corresponding to the MsgA transmission; and a PUCCH transmission used for carrying a second HARQ-ACK feedback, where the second HARQ-ACK feedback is an HARQ-ACK feedback corresponding to an MsgB.

In some implementations, the resources in the above SBFD time units capable of being used by the above PRACH transmission may include: resources corresponding to first ROs. The first ROs are ROs mapped in an uplink subband in SBFD time units.

In some implementations, the resources corresponding to the above first ROs may be configured according to an RO resource configuration mode. The RO resource configuration mode may include any one of the following: an SBFD RO resource configuration mode without introducing an additional PRACH configuration; and an SBFD RO resource configuration mode with introducing an additional PRACH configuration. The additional PRACH configuration may include at least one of the following: a PRACH configuration used for contention-based random access and a PRACH configuration used for non-contention-based random access.

In some implementations, the above RO resource configuration mode includes: the above SBFD RO resource configuration mode without introducing an additional PRACH configuration. The above random access apparatus 100 may further include a first determining module. The first determining module may be configured to determine a first mapping between ROs and SSBs based on an RO mapping mode before the above first execution module 101 executes the above random access in the above random access mode. The RO mapping mode may include any one of the following: a mode of uniformly mapping first valid ROs and second valid ROs to the SSBs; and a mode of respectively mapping the first valid ROs and the second valid ROs to the SSBs. The first valid ROs are valid ROs that are determined based on a first determining rule. The second valid ROs are valid ROs that are determined based on a second determining rule and do not include a valid RO in the first valid ROs. The first determining rule is different from the second determining rule.

In some implementations, the above second determining rule may include: determining that the RO is a valid RO if the RO is entirely located in semi-static uplink time units; and determining that the RO is a valid RO if the RO overlaps with at least one non-semi-static uplink time unit in time domain and the RO meets a first preset condition. The first preset condition may include at least one of the following: no conflict with SSB time units; no conflict with semi-static downlink time units; and no conflict with semi-static flexible time units.

In some implementations, the above RO mapping mode includes: the above mode of uniformly mapping first valid ROs and second valid ROs to the SSBs. The above first determining module may be specifically configured to determine the above first mapping based on a first RO set. The first RO set includes the first valid ROs and the second valid ROs.

In some implementations, the above RO mapping mode includes: the above mode of respectively mapping the first valid ROs and the second valid ROs to the SSBs. The above first mapping includes a first sub-mapping and a second sub-mapping. The above first determining module may be specifically configured to: determine the first sub-mapping according to the first valid ROs; and determine the second sub-mapping according to the second valid ROs.

In some implementations, the resources in the above SBFD time units capable of being used by the PUSCH transmission included in the above target uplink transmission may include: resources corresponding to first POs. The first POs are POs mapped in an uplink subband in SBFD time units.

In some implementations, the above first determining module may be further configured to determine a second mapping between ROs and POs based on a PO mapping mode before the above first execution module 101 executes the above random access in the above random access mode. The PO mapping mode may include at least one of the following:
a mode of uniformly mapping a valid PO set and a second RO set, where the valid PO set may include first valid POs and second valid POs, and the second RO set may include first valid ROs and second valid ROs, or the first valid ROs; and
a mode of mapping the first valid POs and the above first valid ROs and mapping the second valid POs and target valid ROs, where the target valid ROs are the first valid ROs or the above second valid ROs.

The above first valid ROs may be valid ROs that are determined based on a first determining rule. The above second valid ROs may be valid ROs that are determined based on a second determining rule and do not include a valid RO in the first valid ROs. The first determining rule is different from the second determining rule. The above first valid POs may be valid POs that are determined based on a third determining rule. The above second valid POs may be valid POs that are determined based on a fourth determining rule and do not include a valid PO in the first valid POs. The third determining rule is different from the fourth determining rule.

In some implementations, the above fourth determining rule may include: determining that a PO is a valid PO if the entire PO is located in semi-static uplink time units and the PO does not overlap with any third valid ROs in a time domain and a frequency domain; and determining that a PO is a valid PO if the PO overlaps with at least one non-semi-static uplink time unit in time domain, the PO does not overlap with any third valid RO in time domain and frequency domain, and the PO meets a second preset condition. The third valid ROs may include at least one of the above first valid ROs and the above second valid ROs. The second preset condition may include at least one of the following: no conflict with SSB time units; no conflict with semi-static downlink time units; and no conflict with semi-static flexible time units.

In some implementations, the above PO mapping mode includes: the above mode of uniformly mapping a valid PO set and a second RO set. The above first determining module may be specifically configured to map the above valid PO set and the above second RO set to determine the above second mapping.

In some implementations, the above PO mapping mode includes: the above mode of mapping the first valid POs and the first valid ROs and mapping the second valid POs and target valid ROs. The above second mapping includes a third sub-mapping and a fourth sub-mapping. The above first determining module may be specifically configured to: map the first valid POs and the first valid ROs to determine the third sub-mapping; and map the second valid POs and the second valid ROs to determine the fourth sub-mapping.

In some implementations, the above random access mode satisfies: the above PRACH transmission only uses the resources in non-SBFD time units, and the target uplink transmission is capable of using the resources in SBFD time units. Configuration of SBFD notification RACH resources corresponding to the above random access may include at least one of the following: ROs used for an SBFD notification; and PRACH preambles used for the SBFD notification.

In some implementations, the above random access mode satisfies: the above PRACH transmission only uses the resources in non-SBFD time units, and the target uplink transmission is capable of using the resources in SBFD time units. In a case that the target uplink transmission includes only a first uplink transmission, the above random access apparatus 100 is capable of transmitting a notification message to a network device by using a second uplink transmission. The first uplink transmission may include at least one of the following: a PUCCH transmission used for carrying a first HARQ-ACK feedback, where the first HARQ-ACK feedback is an HARQ-ACK feedback corresponding to an Msg4; and a PUCCH transmission used for carrying a second HARQ-ACK feedback, where the second HARQ-ACK feedback is an HARQ-ACK feedback corresponding to an MsgB. The second uplink transmission may include at least one of the following: a PUSCH transmission used for carrying an Msg3; and a PUSCH transmission corresponding to an MsgA transmission. The notification message may be used for notifying the network device of any one of the following: the random access apparatus 100 is an SBFD terminal; and it is expected that an uplink transmission after the second uplink transmission is capable of using the resources in the above SBFD time units.

In the random access apparatus according to the embodiment of this application, the apparatus may execute the random access based on the resources used by the target transmission corresponding to the random access determined by using the random access mode. Therefore, uplink resources in an uplink subband can be flexibly determined and effectively used, thereby improving performance such as a time delay and a capacity of the random access.

The random access apparatus in the embodiment of this application may be an electronic device, such as an electronic device having an operating system, or a component in an electronic device, such as an integrated circuit or a chip. The electronic device may be a terminal. For example, the terminal may include, but is not limited to, the above type of the terminal 11 listed. This is not specifically limited in the embodiment of this application.

The random access apparatus provided in the embodiments of this application can implement the procedures implemented in the above method embodiment on the terminal side, and achieve the same technical effects. To avoid repetition, details are not described herein again.

With reference to FIG. 11, an embodiment of this application further provides another random access apparatus 110. The random access apparatus 110 may include a second execution module 111. The second execution module 111 may be configured to execute random access in a random access mode. The random access mode is used for determining resources used by a target transmission, and the target transmission includes at least one of the following: a PRACH transmission corresponding to the random access and a target uplink transmission during a procedure of the random access.

In some implementations, the above random access mode may include any one of the following: both the above PRACH transmission and the above target uplink transmission only use resources in non-SBFD time units; the PRACH transmission only uses the resources in non-SBFD time units, and the target uplink transmission is capable of using resources in SBFD time units; the PRACH transmission is capable of using the resources in SBFD time units, and the target uplink transmission only uses the resources in non-SBFD time units; both the PRACH transmission and the target uplink transmission are capable of using the resources in SBFD time units; the PRACH transmission only uses the resources in non-SBFD time units; and the PRACH transmission is capable of using the resources in SBFD time units.

In some implementations, the above random access may be four-step random access. The above PRACH transmission may correspond to an Msg1 transmission during the above random access. The above target uplink transmission may include at least one of the following: a PUSCH transmission used for carrying an Msg3; and a PUCCH transmission used for carrying a first HARQ-ACK feedback, where the first HARQ-ACK feedback is an HARQ-ACK feedback corresponding to an Msg4.

In some implementations, the above random access is two-step random access. The above PRACH transmission may correspond to an MsgA transmission during the above random access. The above target uplink transmission may include at least one of the following: a PUSCH transmission corresponding to the MsgA transmission; and a PUCCH transmission used for carrying a second HARQ-ACK feedback, where the second HARQ-ACK feedback is an HARQ-ACK feedback corresponding to an MsgB.

In some implementations, the resources in the above SBFD time units capable of being used by the above PRACH transmission may include: resources corresponding to first ROs. The first ROs are ROs mapped in an uplink subband in SBFD time units.

In some implementations, the resources corresponding to the above first ROs may be configured according to an RO resource configuration mode. The RO resource configuration mode may include any one of the following: an SBFD RO resource configuration mode without introducing an additional PRACH configuration; and an SBFD RO resource configuration mode with introducing an additional PRACH configuration. The additional PRACH configuration may include at least one of the following: a PRACH configuration used for contention-based random access and a PRACH configuration used for non-contention-based random access.

In some implementations, the above RO resource configuration mode includes: the above SBFD RO resource configuration mode without introducing an additional PRACH configuration. The above random access apparatus 110 may further include a second determining module. The second determining module may be configured to determine a first mapping between ROs and SSBs based on an RO mapping mode before the above second execution module 111 executes the above random access in the above random access mode. The RO mapping mode may include any one of the following: a mode of uniformly mapping first valid ROs and second valid ROs to the SSBs; and a mode of respectively mapping the first valid ROs and the second valid ROs to the SSBs. The first valid ROs are valid ROs that are determined based on a first determining rule. The second valid ROs are valid ROs that are determined based on a second determining rule and do not include a valid RO in the first valid ROs. The first determining rule is different from the second determining rule.

In some implementations, the above second determining rule may include: determining that the RO is a valid RO if the RO is entirely located in semi-static uplink time units; and determining that the RO is a valid RO if the RO overlaps with at least one non-semi-static uplink time unit in time domain and the RO meets a first preset condition. The first preset condition may include at least one of the following: no conflict with an SSB time unit; no conflict with semi-static downlink time units; and no conflict with semi-static flexible time units.

In some implementations, the above RO mapping mode includes: the above mode of uniformly mapping first valid ROs and second valid ROs to the SSBs. The above second determining module may be specifically configured to determine the above first mapping based on a first RO set. The first RO set includes the first valid ROs and the second valid ROs.

In some implementations, the above RO mapping mode includes: the above mode of respectively mapping the first valid ROs and the second valid ROs to the SSBs. The above first mapping includes a first sub-mapping and a second sub-mapping. The above second determining module may be specifically configured to: determine the first sub-mapping according to the first valid ROs; and determine the second sub-mapping according to the second valid ROs.

In some implementations, the resources in the above SBFD time units capable of being used by the PUSCH transmission included in the above target uplink transmission may include: resources corresponding to first POs. The first POs are POs mapped in an uplink subband in SBFD time units.

In some implementations, the above second determining module may be further configured to determine a second mapping between ROs and POs based on a PO mapping mode before the above second execution module 111 executes the above random access in the above random access mode. The PO mapping mode may include at least one of the following:
a mode of uniformly mapping a valid PO set and a second RO set, where the valid PO set may include first valid POs and second valid POs, and the second RO set may include first valid ROs and second valid ROs, or the first valid ROs; and
a mode of mapping the first valid POs and the above first valid ROs and mapping the second valid POs and target valid ROs, where the target valid ROs are the first valid ROs or the above second valid ROs.

The above first valid ROs may be valid ROs that are determined based on a first determining rule. The above second valid ROs may be valid ROs that are determined based on a second determining rule and do not include a valid RO in the first valid ROs. The first determining rule is different from the second determining rule. The above first valid POs may be valid POs that are determined based on a third determining rule. The above second valid POs may be valid POs that are determined based on a fourth determining rule and do not include a valid PO in the first valid POs. The third determining rule is different from the fourth determining rule.

In some implementations, the above fourth determining rule may include: determining that a PO is a valid PO if the entire PO is located in semi-static uplink time units and the PO does not overlap with any third valid ROs in a time domain and a frequency domain; and determining that a PO is a valid PO if the PO overlaps with at least one non-semi-static uplink time unit in time domain, the PO does not overlap with any third valid RO in time domain and frequency domain, and the PO meets a second preset condition. The third valid ROs may include at least one of the above first valid ROs and the above second valid ROs. The second preset condition may include at least one of the following: no conflict with SSB time units; no conflict with semi-static downlink time units; and no conflict with semi-static flexible time units.

In some implementations, the above PO mapping mode includes: the above mode of uniformly mapping a valid PO set and a second RO set. The above second determining module may be specifically configured to map the above valid PO set and the above second RO set to determine the above second mapping.

In some implementations, the above PO mapping mode includes: the above mode of mapping the first valid POs and the first valid ROs and mapping the second valid POs and target valid ROs. The above second mapping includes a third sub-mapping and a fourth sub-mapping. The above second determining module may be specifically configured to: map the first valid POs and the first valid ROs to determine the third sub-mapping; and map the second valid POs and the second valid ROs to determine the fourth sub-mapping.

In some implementations, the above random access mode satisfies: the above PRACH transmission only uses the resources in non-SBFD time units, and the target uplink transmission is capable of using the resources in SBFD time units. Configuration of SBFD notification RACH resources corresponding to the above random access may include at least one of the following: ROs used for an SBFD notification; and PRACH preambles used for the SBFD notification.

In some implementations, the above random access mode satisfies: the above PRACH transmission only uses the resources in non-SBFD time units, and the target uplink transmission is capable of using the resources in SBFD time units. In a case that the target uplink transmission includes only a first uplink transmission, the above random access apparatus 110 is capable of receiving a notification message transmitted by a terminal by using a second uplink transmission. The first uplink transmission may include at least one of the following: a PUCCH transmission used for carrying a first HARQ-ACK feedback, where the first HARQ-ACK feedback is an HARQ-ACK feedback corresponding to an Msg4; and a PUCCH transmission used for carrying a second HARQ-ACK feedback, where the second HARQ-ACK feedback is an HARQ-ACK feedback corresponding to an MsgB. The second uplink transmission may include at least one of the following: a PUSCH transmission used for carrying an Msg3; and a PUSCH transmission corresponding to an MsgA transmission. The notification message may be used for notifying the random access apparatus 110 of any one of the following: the terminal is an SBFD terminal; and it is expected that an uplink transmission after the second uplink transmission is capable of using the resources in the above SBFD time units.

In the random access apparatus according to the embodiment of this application, the apparatus may execute the random access based on the resources used by the target transmission corresponding to the random access determined by using the random access mode. Therefore, uplink resources in an uplink subband can be flexibly determined and effectively used, thereby improving performance such as a time delay and a capacity of the random access.

The random access apparatus in the embodiment of this application may be an electronic device, such as an electronic device having an operating system, or a component in an electronic device, such as an integrated circuit or a chip. The electronic device may be another device than the terminal. For example, the another device may be a server, a network attached storage (Network Attached Storage, NAS), or the like. This is not specifically limited in the embodiment of this application.

The random access apparatus provided in the embodiments of this application can implement the procedures implemented in the above method embodiment on the network device, and achieve the same technical effects. To avoid repetition, details are not described herein again.

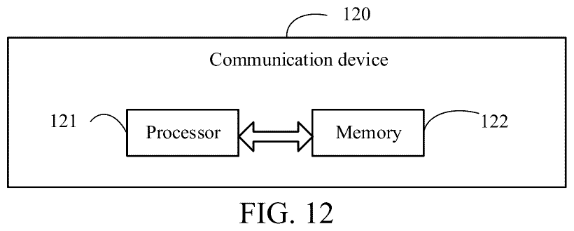

As shown in FIG. 12, an embodiment of this application further provides a communication device 120, including a processor 121 and a memory 122. The memory 122 stores a program or an instruction runnable on the processor 121. For example, in a case that the communication device 120 is a terminal, the program or the instruction, when executed by the processor 121, implements steps of the above method embodiment on the terminal side, and can achieve the same technical effects. When the communication device 120 is a network device, the program or the instruction, when executed by the processor 121, implements steps of the above method embodiment on the network device, and can achieve the same technical effects. To avoid repetition, details are not described herein again.

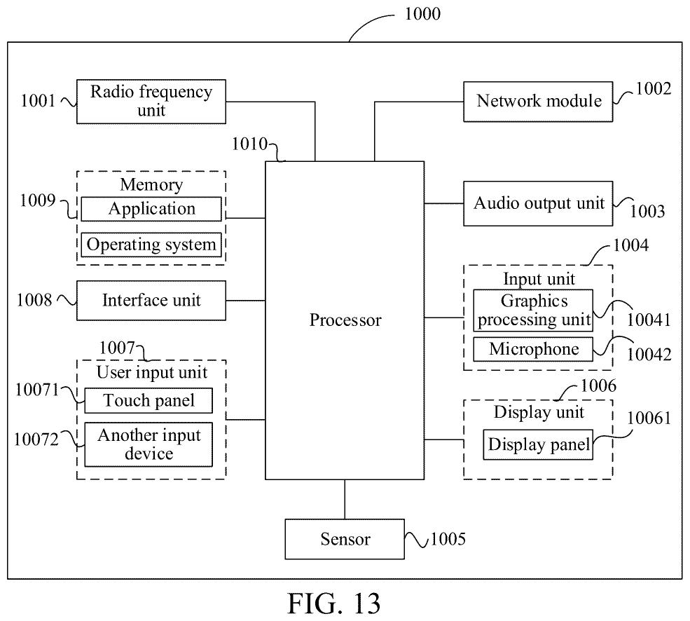

An embodiment of this application further provides a terminal, including a processor and a communication interface. The communication interface is coupled to the processor, and the processor is configured to run a program or an instruction to implement steps of the above method embodiment on the terminal side. The processor may be configured to execute random access in a random access mode. The random access mode is used for determining resources used by a target transmission, and the target transmission includes at least one of the following: a PRACH transmission corresponding to the random access and a target uplink transmission during a procedure of the random access. This terminal embodiment corresponds to the above method embodiment on the terminal side, and each implementation procedure and implementation of the above method embodiment can be applied to the terminal embodiment, and can achieve the same technical effects. Specifically, FIG. 13 is a schematic structural diagram of hardware of a terminal according to an embodiment of this application.

The terminal 1000 includes, but is not limited to, at least some components such as a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (for example, a battery) that supplies power to each component. The power supply may be logically connected to the processor 1010 through a power supply management system, to implement functions such as charging and discharging management, and power consumption management through the power supply management system. A terminal structure shown in FIG. 13 does not limit the terminal. The terminal may include more or fewer components than those shown in the figure, combine some components, or have different component arrangements. Details are not described herein again.

It should be understood that in the embodiment of this application, the input unit 1004 may include a Graphics Processing Unit (GPU) 10041 and a microphone 10042. The graphics processing unit 10041 processes image data of a static picture or video obtained by an image capturing apparatus (for example, a camera) in a video capturing mode or an image capturing mode. The display unit 1006 may include a display panel 10061. The display panel 10061 may be configured in the form of a liquid crystal display, organic light-emitting diodes, or the like. The user input unit 1007 includes at least one of a touch panel 10071 and another input device 10072. The touch panel 10071 is also referred to as a touchscreen. The touch panel 10071 may include two parts: a touch detection apparatus and a touch controller. The another input device 10072 may include, but is not limited to, a physical keyboard, a functional key (such as a volume control key or a switch key), a track ball, a mouse, and a joystick. Details are not described herein again.

In the embodiment of this application, the radio frequency unit 1001 receives downlink data from a network device and then transmits the data to the processor 1010 for processing. In addition, the radio frequency unit 1001 may transmit uplink data to the network device. Generally, the radio frequency unit 1001 includes, but is not limited to, an antenna, an amplifier, a transceiver, a coupler, a low noise amplifier, and a duplexer.

The memory 1009 may be configured to store a software program or instruction and various data. The memory 1009 may mainly include a first storage region storing the program or an instruction and a second storage region storing the data. The first storage region may store an operating system, an application program or an instruction required by at least one function (for example, a sound playback function and an image display function), and the like. Furthermore, the memory 1009 may include a volatile memory or a non-volatile memory. The non-volatile memory may be a Read-Only Memory (ROM), a Programmable Read-Only Memory (PROM), an Erasable Programmable Read-Only Memory (EPROM), an Electrically Erasable Programmable Read-Only Memory (EEPROM), or a flash memory. The volatile memory may be a Random Access Memory (RAM), a Static Random Access Memory (SRAM), a Dynamic Random Access Memory (DRAM), a Synchronous Dynamic Random Access Memory (SDRAM), a Double Data Rate Synchronous Dynamic Random Access Memory (DDR SDRAM), an Enhanced Synchronous Dynamic Random Access Memory (ESDRAM), a Synchlink Dynamic Random Access Memory (SLDRAM), or a Direct Rambus Random Access Memory (DRRAM). The memory 1009 in the embodiment of this application includes but is not limited to these memories and any other memory of a suitable type.

The processor 1010 may include one or more processing units. In some implementations, the processor 1010 integrates an application processor and a modem. The application processor mainly processes operations related to an operating system, a user interface, an application, and the like. The modem mainly processes wireless communication signals, and is, for example, a baseband processor. It may be understood that the above modem may not be integrated into the processor 1010.

The above processor 1010 may be configured to execute random access in a random access mode. The random access mode is used for determining resources used by a target transmission, and the target transmission includes at least one of the following: a PRACH transmission corresponding to the random access and a target uplink transmission during a procedure of the random access.

In some implementations, the above random access mode may include any one of the following: both the above PRACH transmission and the above target uplink transmission only use resources in non-SBFD time units; the PRACH transmission only uses the resources in non-SBFD time units, and the target uplink transmission is capable of using resources in SBFD time units; the PRACH transmission is capable of using the resources in SBFD time units, and the target uplink transmission only uses the resources in non-SBFD time units; both the PRACH transmission and the target uplink transmission are capable of using the resources in SBFD time units; the PRACH transmission only uses the resources in non-SBFD time units; and the PRACH transmission is capable of using the resources in SBFD time units.

In some implementations, the above random access may be four-step random access. The above PRACH transmission may correspond to an Msg1 transmission during the above random access. The above target uplink transmission may include at least one of the following: a PUSCH transmission used for carrying an Msg3; and a PUCCH transmission used for carrying a first HARQ-ACK feedback, where the first HARQ-ACK feedback is an HARQ-ACK feedback corresponding to an Msg4.

In some implementations, the above random access is two-step random access. The above PRACH transmission may correspond to an MsgA transmission during the above random access. The above target uplink transmission may include at least one of the following: a PUSCH transmission corresponding to the MsgA transmission; and a PUCCH transmission used for carrying a second HARQ-ACK feedback, where the second HARQ-ACK feedback is an HARQ-ACK feedback corresponding to an MsgB.

In some implementations, the resources in the above SBFD time units capable of being used by the above PRACH transmission may include: resources corresponding to first ROs. The first ROs are ROs mapped in an uplink subband in SBFD time units.

In some implementations, the resources corresponding to the above first ROs may be configured according to an RO resource configuration mode. The RO resource configuration mode may include any one of the following: an SBFD RO resource configuration mode without introducing an additional PRACH configuration; and an SBFD RO resource configuration mode with introducing an additional PRACH configuration. The additional PRACH configuration may include at least one of the following: a PRACH configuration used for contention-based random access and a PRACH configuration used for non-contention-based random access.

In some implementations, the above RO resource configuration mode includes: the above SBFD RO resource configuration mode without introducing an additional PRACH configuration. The above processor 1010 may be further configured to determine a first mapping between ROs and SSBs based on an RO mapping mode before executing the above random access in the above random access mode. The RO mapping mode may include any one of the following: a mode of uniformly mapping first valid ROs and second valid ROs to the SSBs; and a mode of respectively mapping the first valid ROs and the second valid ROs to the SSBs. The first valid ROs are valid ROs that are determined based on a first determining rule. The second valid ROs are valid ROs that are determined based on a second determining rule and do not include a valid RO in the first valid ROs. The first determining rule is different from the second determining rule.

In some implementations, the above second determining rule may include: determining that the RO is a valid RO if the RO is entirely located in semi-static uplink time units; and determining that the RO is a valid RO if the RO overlaps with at least one non-semi-static uplink time unit in time domain and the RO meets a first preset condition. The first preset condition may include at least one of the following: no conflict with SSB time units; no conflict with semi-static downlink time units; and no conflict with semi-static flexible time units.

In some implementations, the above RO mapping mode includes: the above mode of uniformly mapping first valid ROs and second valid ROs to the SSBs. The above processor 1010 may be specifically configured to determine the above first mapping based on a first RO set. The first RO set includes the first valid ROs and the second valid ROs.

In some implementations, the above RO mapping mode includes: the above mode of respectively mapping the first valid ROs and the second valid ROs to the SSBs. The above first mapping includes a first sub-mapping and a second sub-mapping. The above processor 1010 may be specifically configured to: determine the first sub-mapping according to the first valid ROs; and determine the second sub-mapping according to the second valid ROs.

In some implementations, the resources in the above SBFD time units capable of being used by the PUSCH transmission included in the above target uplink transmission may include: resources corresponding to first POs. The first POs are POs mapped in an uplink subband in SBFD time units.

In some implementations, the above processor 1010 may be further configured to determine a second mapping between ROs and POs based on a PO mapping mode before executing the above random access in the above random access mode. The PO mapping mode may include at least one of the following:
a mode of uniformly mapping a valid PO set and a second RO set, where the valid PO set may include first valid POs and second valid POs, and the second RO set may include first valid ROs and second valid ROs, or the first valid ROs; and
a mode of mapping the first valid POs and the above first valid ROs and mapping the second valid POs and target valid ROs, where the target valid ROs are the first valid ROs or the above second valid ROs.

The above first valid ROs may be valid ROs that are determined based on a first determining rule. The above second valid ROs may be valid ROs that are determined based on a second determining rule and do not include a valid RO in the first valid ROs. The first determining rule is different from the second determining rule. The above first valid POs may be valid POs that are determined based on a third determining rule. The above second valid POs may be valid POs that are determined based on a fourth determining rule and do not include a valid PO in the first valid POs. The third determining rule is different from the fourth determining rule.

In some implementations, the above fourth determining rule may include: determining that a PO is a valid PO if the entire PO is located in semi-static uplink time units and the PO does not overlap with any third valid ROs in a time domain and a frequency domain; and determining that a PO is a valid PO if the PO overlaps with at least one non-semi-static uplink time unit in time domain, the PO does not overlap with any third valid RO in time domain and frequency domain, and the PO meets a second preset condition. The third valid ROs may include at least one of the above first valid ROs and the above second valid ROs. The second preset condition may include at least one of the following: no conflict with SSB time units; no conflict with semi-static downlink time units; and no conflict with semi-static flexible time units.

In some implementations, the above PO mapping mode includes: the above mode of uniformly mapping a valid PO set and a second RO set. The above processor 1010 may be specifically configured to map the above valid PO set and the above second RO set to determine the above second mapping.

In some implementations, the above PO mapping mode includes: the above mode of mapping the first valid POs and the first valid ROs and mapping the second valid POs and target valid ROs. The above second mapping includes a third sub-mapping and a fourth sub-mapping. The above processor 1010 may be specifically configured to: map the first valid POs and the first valid ROs to determine the third sub-mapping; and map the second valid POs and the second valid ROs to determine the fourth sub-mapping.

In some implementations, the above random access mode satisfies: the above PRACH transmission only uses the resources in non-SBFD time units, and the target uplink transmission is capable of using the resources in SBFD time units. Configuration of SBFD notification RACH resources corresponding to the above random access may include at least one of the following: ROs used for an SBFD notification; and PRACH preambles used for the SBFD notification.

In some implementations, the above random access mode satisfies: the above PRACH transmission only uses the resources in non-SBFD time units, and the target uplink transmission is capable of using the resources in SBFD time units. In a case that the target uplink transmission includes only a first uplink transmission, the above terminal 1000 is capable of transmitting a notification message to a network device by using a second uplink transmission. The first uplink transmission may include at least one of the following: a PUCCH transmission used for carrying a first HARQ-ACK feedback, where the first HARQ-ACK feedback is an HARQ-ACK feedback corresponding to an Msg4; and a PUCCH transmission used for carrying a second HARQ-ACK feedback, where the second HARQ-ACK feedback is an HARQ-ACK feedback corresponding to an MsgB. The second uplink transmission may include at least one of the following: a PUSCH transmission used for carrying an Msg3; and a PUSCH transmission corresponding to an MsgA transmission. The notification message may be used for notifying the network device of any one of the following: the terminal 1000 is an SBFD terminal; and it is expected that an uplink transmission after the second uplink transmission is capable of using the resources in the above SBFD time units.

In the terminal according to the embodiment of this application, the terminal may execute the random access based on the resources used by the target transmission corresponding to the random access determined by using the random access mode. Therefore, uplink resources in an uplink subband can be flexibly determined and effectively used, thereby improving performance such as a time delay and a capacity of the random access.

It can be understood that for the implementation procedure of each implementation mentioned in the embodiment, reference can be made to the relevant description of the above method embodiment on the terminal side, and the same or corresponding technical effects can be achieved. To avoid repetition, details are not described herein again.

An embodiment of this application further provides a network device, including a processor and a communication interface. The communication interface is coupled to the processor, and the processor is configured to run a program or an instruction to implement steps of the above method embodiment on the network device. The processor may be configured to execute random access in a random access mode. The random access mode is used for determining resources used by a target transmission, and the target transmission includes at least one of the following: a PRACH transmission corresponding to the random access and a target uplink transmission during a procedure of the random access. This network device embodiment corresponds to the above method embodiment on the network device. Each implementation procedure and implementation of the above method embodiment can be applied to the network device embodiment, and can achieve the same technical effects.

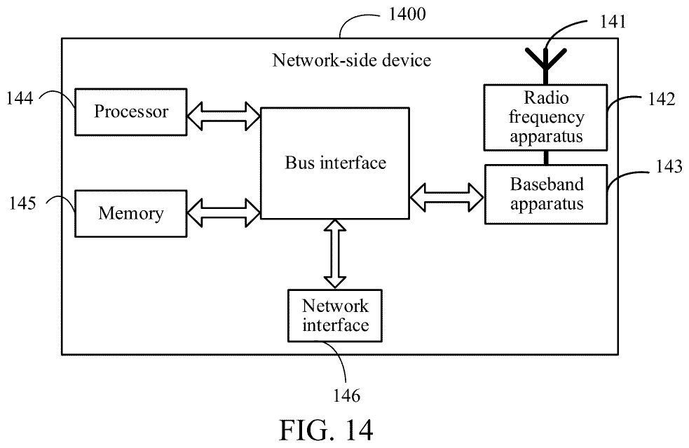

In some implementations, an embodiment of this application further provides a network device. As shown in FIG. 14, the network device 1400 includes: an antenna 141, a radio frequency apparatus 142, a baseband apparatus 143, a processor 144, and a memory 145. The antenna 141 is connected to the radio frequency apparatus 142. In an uplink direction, the radio frequency apparatus 142 receives information by using the antenna 141, and transmits the received information to the baseband apparatus 143 for processing. In a downlink direction, the baseband apparatus 143 processes to-be-sent information, and transmits the processed to-be-sent information to the radio frequency apparatus 142. The radio frequency apparatus 142 processes the received information, and then transmits the processed information through the antenna 141.

The method executed by the network device in the above embodiment may be implemented by the baseband apparatus 143. The baseband apparatus 143 includes a baseband processor.

The baseband apparatus 143 may include, for example, at least one baseband board. The baseband board is provided with a plurality of chips. As shown in FIG. 14, one of the chips is, for example, a baseband processor, and is connected to the memory 145 through a bus interface, such that a program in the memory 145 is invoked to execute operations of a network device shown in the method embodiment.

The network device may further include a network interface 146. The interface is, for example, a Common Public Radio Interface (CPRI).

In some implementations, the network device 1400 in the embodiment of this application further includes: an instruction or a program stored in the memory 145 and runnable on the processor 144. The processor 144 invokes the instruction or the program stored in the memory 145 to execute the method executed by various modules shown in FIG. 11, and can achieve the same technical effects. To avoid repetition, details are not described herein again.

The above processor 144 may be configured to execute random access in a random access mode. The random access mode is used for determining resources used by a target transmission, and the target transmission includes at least one of the following: a PRACH transmission corresponding to the random access and a target uplink transmission during a procedure of the random access.

In some implementations, the above random access mode may include any one of the following: both the above PRACH transmission and the above target uplink transmission only use resources in non-SBFD time units; the PRACH transmission only uses the resources in non-SBFD time units, and the target uplink transmission is capable of using resources in SBFD time units; the PRACH transmission is capable of using the resources in SBFD time units, and the target uplink transmission only uses the resources in non-SBFD time units; both the PRACH transmission and the target uplink transmission are capable of using the resources in SBFD time units; the PRACH transmission only uses the resources in non-SBFD time units; and the PRACH transmission is capable of using the resources in SBFD time units.

In some implementations, the above random access may be four-step random access. The above PRACH transmission may correspond to an Msg1 transmission during the above random access. The above target uplink transmission may include at least one of the following: a PUSCH transmission used for carrying an Msg3; and a PUCCH transmission used for carrying a first HARQ-ACK feedback, where the first HARQ-ACK feedback is an HARQ-ACK feedback corresponding to an Msg4.

In some implementations, the above random access is two-step random access. The above PRACH transmission may correspond to an MsgA transmission during the above random access. The above target uplink transmission may include at least one of the following: a PUSCH transmission corresponding to the MsgA transmission; and a PUCCH transmission used for carrying a second HARQ-ACK feedback, where the second HARQ-ACK feedback is an HARQ-ACK feedback corresponding to an MsgB.

In some implementations, the resources in the above SBFD time units capable of being used by the above PRACH transmission may include: resources corresponding to first ROs. The first ROs are ROs mapped in an uplink subband in SBFD time units.

In some implementations, the resources corresponding to the above first ROs may be configured according to an RO resource configuration mode. The RO resource configuration mode may include any one of the following: an SBFD RO resource configuration mode without introducing an additional PRACH configuration; and an SBFD RO resource configuration mode with introducing an additional PRACH configuration. The additional PRACH configuration may include at least one of the following: a PRACH configuration used for contention-based random access and a PRACH configuration used for non-contention-based random access.

In some implementations, the above RO resource configuration mode includes: the above SBFD RO resource configuration mode without introducing an additional PRACH configuration. The above processor 144 may be further configured to determine a first mapping between ROs and SSBs based on an RO mapping mode before executing above the random access in the above random access mode. The RO mapping mode may include any one of the following: a mode of uniformly mapping first valid ROs and second valid ROs to the SSBs; and a mode of respectively mapping the first valid ROs and the second valid ROs to the SSBs. The first valid ROs are valid ROs that are determined based on a first determining rule. The second valid ROs are valid ROs that are determined based on a second determining rule and do not include a valid RO in the first valid ROs. The first determining rule is different from the second determining rule.

In some implementations, the above second determining rule may include: determining that the RO is a valid RO if the RO is entirely located in semi-static uplink time units; and determining that the RO is a valid RO if the RO overlaps with at least one non-semi-static uplink time unit in time domain and the RO meets a first preset condition. The first preset condition may include at least one of the following: no conflict with SSB time units; no conflict with semi-static downlink time units; and no conflict with semi-static flexible time units.

In some implementations, the above RO mapping mode includes: the above mode of uniformly mapping first valid ROs and second valid ROs to the SSBs. The above processor 144 may be specifically configured to determine the above first mapping based on a first RO set. The first RO set includes the first valid ROs and the second valid ROs.

In some implementations, the above RO mapping mode includes: the above mode of respectively mapping the first valid ROs and the second valid ROs to the SSBs. The above first mapping includes a first sub-mapping and a second sub-mapping. The above processor 144 may be specifically configured to: determine the first sub-mapping according to the first valid ROs; and determine the second sub-mapping according to the second valid ROs.

In some implementations, the resources in the above SBFD time units capable of being used by the PUSCH transmission included in the above target uplink transmission may include: resources corresponding to first POs. The first POs are POs mapped in an uplink subband in SBFD time units.

In some implementations, the above processor 144 may be further configured to determine a second mapping between ROs and POs based on a PO mapping mode before executing the above random access in the above random access mode. The PO mapping mode may include at least one of the following:
a mode of uniformly mapping a valid PO set and a second RO set, where the valid PO set may include first valid POs and second valid POs, and the second RO set may include first valid ROs and second valid ROs, or the first valid ROs; and
a mode of mapping the first valid POs and the above first valid ROs and mapping the second valid POs and target valid ROs, where the target valid ROs are the first valid ROs or the above second valid ROs.

The above first valid ROs may be valid ROs that are determined based on a first determining rule. The above second valid ROs may be valid ROs that are determined based on a second determining rule and do not include a valid RO in the first valid ROs. The first determining rule is different from the second determining rule. The above first valid POs may be valid POs that are determined based on a third determining rule. The above second valid POs may be valid POs that are determined based on a fourth determining rule and do not include a valid PO in the first valid POs. The third determining rule is different from the fourth determining rule.

In some implementations, the above fourth determining rule may include: determining that a PO is a valid PO if the entire PO is located in semi-static uplink time units and the PO does not overlap with any third valid ROs in a time domain and a frequency domain; and determining that a PO is a valid PO if the PO overlaps with at least one non-semi-static uplink time unit in time domain, the PO does not overlap with any third valid RO in time domain and frequency domain, and the PO meets a second preset condition. The third valid ROs may include at least one of the above first valid ROs and the above second valid ROs. The second preset condition may include at least one of the following: no conflict with SSB time units; no conflict with semi-static downlink time units; and no conflict with semi-static flexible time units.

In some implementations, the above PO mapping mode includes: the above mode of uniformly mapping a valid PO set and a second RO set. The above processor 144 may be specifically configured to map the above valid PO set and the above second RO set to determine the above second mapping.

In some implementations, the above PO mapping mode includes: the above mode of mapping the first valid POs and the first valid ROs and mapping the second valid POs and target valid ROs. The above second mapping includes a third sub-mapping and a fourth sub-mapping. The above processor 144 may be specifically configured to: map the first valid POs and the first valid ROs to determine the third sub-mapping; and map the second valid POs and the second valid ROs to determine the fourth sub-mapping.

In some implementations, the above random access mode satisfies: the above PRACH transmission only uses the resources in non-SBFD time units, and the target uplink transmission is capable of using the resources in SBFD time units. Configuration of SBFD notification RACH resources corresponding to the above random access may include at least one of the following: ROs used for an SBFD notification; and PRACH preambles used for the SBFD notification.

In some implementations, the above random access mode satisfies: the above PRACH transmission only uses the resources in non-SBFD time units, and the target uplink transmission is capable of using the resources in SBFD time units. In a case that the target uplink transmission includes only a first uplink transmission, the above network device 1400 is capable of receiving, by using a second uplink transmission, a notification message transmitted by a terminal. The first uplink transmission may include at least one of the following: a PUCCH transmission used for carrying a first HARQ-ACK feedback, where the first HARQ-ACK feedback is an HARQ-ACK feedback corresponding to an Msg4; and a PUCCH transmission used for carrying a second HARQ-ACK feedback, where the second HARQ-ACK feedback is an HARQ-ACK feedback corresponding to an MsgB. The second uplink transmission may include at least one of the following: a PUSCH transmission used for carrying an Msg3; and a PUSCH transmission corresponding to an MsgA transmission. The notification message may be used for notifying the network device 1400 of any one of the following: the terminal is an SBFD terminal; and it is expected that an uplink transmission after the second uplink transmission is capable of using the resources in the above SBFD time units.

In the network device according to the embodiment of this application, the network device may execute the random access based on the resources used by the target transmission corresponding to the random access determined by using the random access mode. Therefore, uplink resources in an uplink subband can be flexibly determined and effectively used, thereby improving performance such as a time delay and a capacity of the random access.

It can be understood that for the implementation procedure of each implementation mentioned in the embodiment, reference can be made to the relevant description of the above method embodiment on the network device, and the same or corresponding technical effects can be achieved. To avoid repetition, details are not described herein again.

Embodiments of this application further provide a readable storage medium. The readable storage medium stores a program or an instruction. When the program or the instruction is executed by a processor, each procedure of the above embodiments of the random access method is executed, and the same technical effects may be achieved. To avoid repetition, details are not described herein again.

The processor is a processor in the terminal described in the above embodiments. The readable storage medium includes a computer-readable storage medium, such as a computer ROM, a RAM, a magnetic disk, or an optical disk. In some examples, the readable storage medium may be a non-transitory readable storage medium.

Embodiments of this application further provide a chip. The chip includes a processor and a communication interface. The communication interface is coupled to the processor, and the processor is configured to run a program or an instruction to implement each procedure of the above embodiments of the random access method. The same technical effects may be achieved. To avoid repetition, details are not described herein again.

It should be understood that the chip mentioned in the embodiment of this application may also be referred to as a system level chip, a system chip, a chip system, a system on chip, or the like.

An embodiment of this application further provides a computer program/program product. The computer program/program product is stored in a storage medium. The computer program/program product, when executed by at least one processor, implements each procedure in the above embodiments of the random access method, and can achieve the same technical effects. To avoid repetition, details are not described herein again.

Embodiments of this application further provide a communication system, including: a terminal and a network device. The terminal may be configured to execute the steps of the above method on a terminal side. The network device may be configured to execute the steps of the above method on a network device.

It should be noted that in this specification, the term “include,” “comprise,” or any other variants thereof are intended to encompass in a non-exclusive mode, so that a procedure, a method, an object, or an apparatus including a series of elements not only includes those elements, but also includes other elements that are not explicitly listed, or elements that are inherent to such a procedure, a method, an object, or an apparatus. Without more limitations, an element defined by a sentence “including one . . . ” does not exclude existence of other same elements in the procedure, the method, the object, or the apparatus that includes the element. In addition, it should be noted that the scope of the method and the apparatus in the implementations of this application is not limited to performing functions according to a sequence that is shown or discussed, but may further include performing functions in a substantially simultaneous mode or in a reversed sequence according to the functions involved. For example, the described method may be performed in a different order than a described order, and various steps may be added, omitted, or combined. In addition, features described with reference to some examples may be combined in other examples.

Through the description of the above implementations, a person skilled in the art may clearly understand that the methods according to the above embodiments may be implemented by a computer software product and a necessary general hardware platform, and certainly, may alternatively be implemented by hardware. The computer software product is stored in a storage medium (such as a ROM, a RAM, a magnetic disk, or an optical disc) and includes several instructions for enabling a terminal or a network device to perform the methods described in the embodiments of this application.

The embodiments of this application are described above with reference to the accompanying drawings. However, this application is not limited to the specific implementations described above, and the specific implementations described above are only exemplary and not limitative. A person of ordinary skill in the art may make many forms of implementations under the teaching of this application without departing from the spirit of this application and the protection scope of the claims, and such implementations shall all fall within the protection scope of this application.

What is claimed is:

1. A random access method, performed by a terminal, comprising:
executing a random access in a random access mode,
wherein the random access mode is used for determining resources used by a target transmission, and the target transmission comprises at least one of the following:
a Physical Random Access CHannel (PRACH) transmission corresponding to the random access or a target uplink transmission during a procedure of the random access.

2. The random access method according to claim 1, wherein
the random access mode satisfies any one of the following:
both the PRACH transmission and the target uplink transmission only use resources in non-SubBand Full Duplex (SBFD) time units;
the PRACH transmission only uses the resources in non-SBFD time units, and the target uplink transmission is capable of using resources in SBFD time units;
the PRACH transmission is capable of using the resources in SBFD time units, and the target uplink transmission only uses the resources in non-SBFD time units;
both the PRACH transmission and the target uplink transmission are capable of using the resources in SBFD time units;
the PRACH transmission only uses the resources in non-SBFD time units; or
the PRACH transmission is capable of using the resources in SBFD time units.

3. The random access method according to claim 2, wherein the random access is a four-step random access;
the PRACH transmission corresponds to a Message 1 (Msg1) transmission during the procedure of the random access; and
the target uplink transmission comprises at least one of the following:
a Physical Uplink Shared CHannel (PUSCH) transmission used for carrying a message 3 (Msg3); or
a Physical Uplink Control CHannel (PUCCH) transmission used for carrying a first Hybrid Automatic Repeat reQuest ACKnowledgement (HARQ-ACK) feedback, wherein the first HARQ-ACK feedback is an HARQ-ACK feedback corresponding to a Message 4 (Msg4).

4. The random access method according to claim 2, wherein the resources in SBFD time units capable of being used by the PRACH transmission comprise: resources corresponding to first PRACH Occasions (ROs),
wherein the first ROs are ROs mapped in an uplink subband in SBFD time units.

5. The random access method according to claim 4, wherein the resources corresponding to the first ROs are configured according to an RO resource configuration mode; and
the RO resource configuration mode satisfies any one of the following:
an SBFD RO resource configuration mode without introducing an additional PRACH configuration; or
an SBFD RO resource configuration mode with introducing an additional PRACH configuration,
wherein the additional PRACH configuration comprises at least one of the following: a PRACH configuration used for contention-based random access or a PRACH configuration used for non-contention-based random access.

6. The random access method according to claim 5, wherein the RO resource configuration mode satisfies: the SBFD RO resource configuration mode without introducing an additional PRACH configuration;
before the executing a random access in a random access mode, the random access method further comprises:
determining a first mapping between ROs and Synchronization Signal Blocks (SSBs) based on an RO mapping mode; and
the RO mapping mode satisfies any one of the following:
a mode of uniformly mapping first valid ROs and second valid ROs to the SSBs; or
a mode of respectively mapping the first valid ROs and the second valid ROs to the SSBs,
wherein the first valid ROs are valid ROs that are determined based on a first determining rule; the second valid ROs are valid ROs that are determined based on a second determining rule and do not comprise a valid RO in the first valid ROs; and the first determining rule is different from the second determining rule.

7. The random access method according to claim 6, wherein
the second determining rule comprises:
determining that the RO is a valid RO when the RO is entirely located in semi-static uplink time units; and
determining that the RO is a valid RO when the RO overlaps with at least one non-semi-static uplink time unit in time domain and the RO meets a first preset condition,
wherein the first preset condition comprises at least one of the following:
no conflict with SSB time units;
no conflict with semi-static downlink time units; or
no conflict with semi-static flexible time units.

8. The random access method according to claim 6, wherein:
determining that the RO conflicts with SSB time units when at least one of the following is met:
time-frequency resources of the RO and SSB time units overlap;
the RO and SSB time units overlap in a time domain, but do not overlap in a frequency domain;
N_gap time units before the RO and SSB time units overlap in a time domain; or
the RO is located before SSB time units of one PRACH slot;
determining that the RO conflicts with semi-static downlink time units when at least one of the following is met:
semi-static downlink time units are determined as non-SBFD time units based on a configuration or indication, and the RO overlaps with semi-static downlink time units in a time domain;
semi-static downlink time units are determined as non-SBFD time units based on a configuration or indication, and N_gap symbols before the RO overlap with semi-static downlink time units in a time domain;
semi-static downlink time units are determined as SBFD time units based on a configuration or indication, and the RO overlaps with semi-static downlink time units in a time domain;
semi-static downlink time units are determined as SBFD time units based on a configuration or indication, the RO overlaps with semi-static downlink time units in a time domain, and at the overlap in the time domain, the RO overlaps with a downlink subband or a guard band in a frequency domain; or
semi-static downlink time units are determined as SBFD time units based on a configuration or indication, and N_gap symbols before the RO overlap with semi-static downlink time units in a time domain; and
determining that the RO conflicts with semi-static flexible time units when at least one of the following is met:
semi-static flexible time units are determined as SBFD time units based on a configuration or indication, and the RO overlaps with semi-static flexible time units in a time domain;
semi-static flexible time units are determined as SBFD time units based on a configuration or indication, the RO overlaps with semi-static flexible time units in a time domain, and at the overlap in the time domain, the RO overlaps with a downlink subband or a guard band in a frequency domain; or
semi-static flexible time units are determined as SBFD time units based on a configuration or indication, and N_gap symbols before the RO overlap with semi-static flexible time units in a time domain.

9. The random access method according to claim 6, wherein the RO mapping mode satisfies: the mode of respectively mapping the first valid ROs and the second valid ROs to the SSBs; and the first mapping comprises a first sub-mapping and a second sub-mapping; and
the determining a first mapping between ROs and SSBs based on an RO mapping mode comprises:
determining the first sub-mapping according to the first valid ROs; and
determining the second sub-mapping according to the second valid ROs.

10. A random access method, comprising:
executing, by a network device, random access in a random access mode,
wherein the random access mode is used for determining resources used by a target transmission, and the target transmission comprises at least one of the following: a PRACH transmission corresponding to the random access or a target uplink transmission during a procedure of the random access.

11. The random access method according to claim 10, wherein
the random access mode satisfies any one of the following:
both the PRACH transmission and the target uplink transmission only use resources in non-SBFD time units;
the PRACH transmission only uses the resources in non-SBFD time units, and the target uplink transmission is capable of using resources in SBFD time units;
the PRACH transmission is capable of using the resources in SBFD time units, and the target uplink transmission only uses the resources in non-SBFD time units;
both the PRACH transmission and the target uplink transmission are capable of using the resources in SBFD time units;
the PRACH transmission only uses the resources in non-SBFD time units; or
the PRACH transmission is capable of using the resources in SBFD time units.

12. The random access method according to claim 11, wherein the random access mode satisfies: the PRACH transmission only uses the resources in non-SBFD time units, and the target uplink transmission is capable of using the resources in SBFD time units,
wherein configuration of SBFD notification RACH resources corresponding to the random access comprises at least one of the following:
ROs used for an SBFD notification; or
PRACH preambles used for the SBFD notification.

13. The random access method according to claim 11, wherein the random access mode satisfies: the PRACH transmission only uses the resources in non-SBFD time units, and the target uplink transmission is capable of using the resources in SBFD time units; and
in a case that the target uplink transmission comprises only a first uplink transmission, the network device is capable of receiving, by using a second uplink transmission, a notification message transmitted by a terminal,
wherein the first uplink transmission comprises at least one of the following: a PUCCH transmission used for carrying a first HARQ-ACK feedback, wherein the first HARQ-ACK feedback is an HARQ-ACK feedback corresponding to an Msg4; or a PUCCH transmission used for carrying a second HARQ-ACK feedback, wherein the second HARQ-ACK feedback is an HARQ-ACK feedback corresponding to an MsgB;
the second uplink transmission comprises at least one of the following: a PUSCH transmission used for carrying an Msg3; or a PUSCH transmission corresponding to an MsgA transmission; and
the notification message is used for notifying the network device of any one of the following: the terminal is an SBFD terminal; or it is expected that an uplink transmission after the second uplink transmission is capable of using the resources in SBFD time units.

14. A terminal, comprising:
a memory storing computer-readable instructions; and
a processor coupled to the memory and configured to execute the computer-readable instructions, wherein the computer-readable instructions, when executed by the processor, cause the processor to perform operations comprising:
executing a random access in a random access mode,
wherein the random access mode is used for determining resources used by a target transmission, and the target transmission comprises at least one of the following:
a Physical Random Access CHannel (PRACH) transmission corresponding to the random access or a target uplink transmission during a procedure of the random access.

15. The terminal according to claim 14, wherein
the random access mode satisfies any one of the following:
both the PRACH transmission and the target uplink transmission only use resources in non-SubBand Full Duplex (SBFD) time units;
the PRACH transmission only uses the resources in non-SBFD time units, and the target uplink transmission is capable of using resources in SBFD time units;
the PRACH transmission is capable of using the resources in SBFD time units, and the target uplink transmission only uses the resources in non-SBFD time units;
both the PRACH transmission and the target uplink transmission are capable of using the resources in SBFD time units;
the PRACH transmission only uses the resources in non-SBFD time units; or
the PRACH transmission is capable of using the resources in SBFD time units.

16. The terminal according to claim 15, wherein the random access is a four-step random access;
the PRACH transmission corresponds to a Message 1 (Msg1) transmission during the procedure of the random access; and
the target uplink transmission comprises at least one of the following:
a Physical Uplink Shared CHannel (PUSCH) transmission used for carrying a message 3 (Msg3); or
a Physical Uplink Control CHannel (PUCCH) transmission used for carrying a first Hybrid Automatic Repeat reQuest ACKnowledgement (HARQ-ACK) feedback, wherein the first HARQ-ACK feedback is an HARQ-ACK feedback corresponding to a Message 4 (Msg4).

17. The terminal according to claim 15, wherein the resources in SBFD time units capable of being used by the PRACH transmission comprise: resources corresponding to first PRACH Occasions (ROs),
wherein the first ROs are ROs mapped in an uplink subband in SBFD time units.

18. The terminal according to claim 17, wherein the resources corresponding to the first ROs are configured according to an RO resource configuration mode; and
the RO resource configuration mode satisfies any one of the following:
an SBFD RO resource configuration mode without introducing an additional PRACH configuration; or
an SBFD RO resource configuration mode with introducing an additional PRACH configuration,
wherein the additional PRACH configuration comprises at least one of the following: a PRACH configuration used for contention-based random access or a PRACH configuration used for non-contention-based random access.

19. The terminal according to claim 18, wherein the RO resource configuration mode satisfies: the SBFD RO resource configuration mode without introducing an additional PRACH configuration;
before the executing a random access in a random access mode, the operations further comprise:
determining a first mapping between ROs and Synchronization Signal Blocks (SSBs) based on an RO mapping mode; and
the RO mapping mode satisfies any one of the following:
a mode of uniformly mapping first valid ROs and second valid ROs to the SSBs; or
a mode of respectively mapping the first valid ROs and the second valid ROs to the SSBs,
wherein the first valid ROs are valid ROs that are determined based on a first determining rule; the second valid ROs are valid ROs that are determined based on a second determining rule and do not comprise a valid RO in the first valid ROs; and the first determining rule is different from the second determining rule.

20. The terminal according to claim 19, wherein
the second determining rule comprises:
determining that the RO is a valid RO when the RO is entirely located in semi-static uplink time units; and
determining that the RO is a valid RO when the RO overlaps with at least one non-semi-static uplink time unit in time domain and the RO meets a first preset condition,
wherein the first preset condition comprises at least one of the following:
no conflict with SSB time units;
no conflict with semi-static downlink time units; or
no conflict with semi-static flexible time units.
